(19) United States
(12) Patent Application Publication
(10) Pub. No.: US 2017/0280448 A1
(43) Pub. Date: Sep. 28, 2017

(54) USER TERMINAL, RADIO BASE STATION AND RADIO COMMUNICATION METHOD

(71) Applicant: NTT DOCOMO, INC., Tokyo (JP)

(72) Inventors: Kazuki Takeda, Tokyo (JP); Satoshi Nagata, Tokyo (JP); Jing Wang, Beijing (CN); Liu Liu, Beijing (CN); Huiling Jiang, Beijing (CN)

(73) Assignee: NTT DOCOMO, INC., Tokyo (JP)

(21) Appl. No.: 15/514,012

(22) PCT Filed: Sep. 25, 2015
(86) PCT No.: PCT/JP2015/077040

§ 371 Date: Mar. 24, 2017

(30) Foreign Application Priority Data
Sep. 25, 2014 (JP) 2014-195457

(51) Int. Cl. H04W 72/04; H04L 5/14; H04L 1/18; H04W 74/08

(52) U.S. Cl. CPC H04W 72/0446; H04W 74/0808; H04L 5/14; H04L 1/1861

(57) ABSTRACT

In order to prevent deterioration in communication quality even when LBT applies to UL transmission, the present invention provides a user terminal that has: a transmission section that transmits a transmission acknowledgement signal for a DL (downlink) data signal transmitted from a radio base station; and a control section that controls transmission of the transmission acknowledgement signal based on an LBT (Listen Before Talk) result in uplink. When transmitting the transmission acknowledgement signal in a given UL (uplink) subframe, the control section determines a feedback timing of the transmission acknowledgement signal in accordance with the LBT result in a UL subframe prior to the given UL subframe.

### TECHNICAL FIELD

The present invention relates to a user terminal, a radio base station and a radio communication method applicable to a next-generation communication system.

### BACKGROUND ART

In a UMTS (Universal Mobile Telecommunications System) network, for the purposes of achieving higher-speed data rates, providing low delay and so on, long-term evolution (LTE) has been standardized (see Non Patent Literature 1). In LTE, as multi access schemes, an OFDMA (Orthogonal Frequency Division Multiple Access)-based scheme is used for downlink and an SC-FDMA (Single Carrier Frequency Division Multiple Access)-based scheme is used for uplink. For the purposes of achieving further broadbandization and higher speed beyond LTE, successor systems to LTE have been also studied and standardized (Rel. 10/11) (for example, such a system is also called “LTE advanced” or “LTE enhancement” (hereinafter referred to as “LTE-A”)).

In the LTE-A system, HetNet (Heterogeneous Network) has been also studied in which a macro cell is formed having a wide coverage area of about several kilo meter radius, and a small cell (for example, pico cell, femto cell or the like) having a local coverage area of about several ten meter radius is formed within the macro cell. In the HetNet environment, it has been considered that the macro cell (macro base station) and the small cell (small base station) use not only carriers of the same frequency band but also carriers of different frequency bands.

Further, in a future radio communication system (Rel. 12 or later), the LTE system has been considered as operating not only in a licensed frequency band that is a frequency band licensed to a communication carrier (operator) but also in an unlicensed frequency band that is a license-not-required frequency band (which system is called LTE-U: LTE Unlicensed). Particularly, there has been also considered a system operating the unlicensed band on the licensed band condition (which system is called LAA (Licensed-Assisted Access)). A system operating LTE/LTE-A in the unlicensed band is sometimes called “LAA” collectively. The licensed band is a band that is permitted to be used exclusively by a specific operator (carrier), while the unlicensed band (also called “non-licensed band”) is a band in which a radio base station is able to be installed without limitation to a specific operator.

As the unlicensed band, a 2.4 GHz or 5 GHz band, in which Wi-Fi (registered trademark) and Bluetooth (registered trademark) are usable, and a 60 GHz band, in which milli-meter wave is usable, have been considered to be used. This unlicensed band has been also considered to be applied to a small cell.

### CITATION LIST

### Non-Patent Literature

Non-Patent Literature 1: 3GPP TS 36.300 “Evolved UTRA and Evolved UTRAN Overall description”

### SUMMARY OF THE INVENTION

### Technical Problem

The existing LTE is expected to operate in the licensed band and therefore, operators are assigned with mutually different frequency bands. However, as for the unlicensed band, its use is not limited to a specific operator unlike the licensed band. In addition, use of the unlicensed band is not limited to a specific radio system unlike the licensed band (for example, the licensed band operation is limited to LTE, Wi-Fi or the like). Therefore, the frequency band used by LAA of a certain operator may overlap a frequency band used by LAA or Wi-Fi of another operator.

Operation in the unlicensed band is sometimes expected to be performed without synchronization, coordination and cooperation between different operators and non-operators. Besides, installation of a radio access point (also called AP, TP) and a radio base station (eNB) is also expected to be performed without coordination and cooperation between different operators and non-operators. In this case, dense cell planning and interference control are difficult to execute, which may cause great mutual interference in the unlicensed band, unlike in the licensed band.

Therefore, when operating LBT/LTE-A system (LTE-U) in the unlicensed band, it is desired that operation should be performed in consideration of mutual interference with another system such as Wi-Fi and LTE-U of another operator operating in the unlicensed band. In order to avoid mutual interference in the unlicensed band, it has been considered that an LTE-U base station/user terminal performs listening prior to signal transmission and checks if another base station/user terminal is in communication. This listening operation is called LBT (Listen Before Talk).

However, when the LTE-U base station/user terminal controls transmission based on an LBT result (for example, determines whether to allow transmission or not), signal transmission is sometimes restricted depending on the LBT result and may be impossible at a given timing. In such a case, there may occur signal delay, signal disconnection, cell detection error in LTE-U or the like, thereby causing deterioration in signal quality.

For example, in the LTE/LTE-A system, a user terminal feeds back a retransmission acknowledgement signal (called HARQ-ACK or A/N) in response to a DL data signal at given timing. However, if UL transmission is limited depending on the UL-LBT result, it may be difficult to feed back a retransmission acknowledgement signal. As a result, a radio base station is not able to know a reception situation of a DL signal in the user terminal, which may cause deterioration in communication quality.

The present invention was carried out in view of the foregoing and aims to provide a user terminal, a radio base station and a radio communication method that are capable of preventing deterioration in communication quality even when LBT is applied to UL transmission.

### Solution to Problem

An aspect of the present invention provides a user terminal comprising: a transmission section that transmits a transmission acknowledgement signal for a DL (downlink) data signal transmitted from a radio base station; and a control section that controls transmission of the transmission acknowledgement signal based on an LBT (Listen Before Talk) result in uplink, wherein when transmitting the transmission acknowledgement signal in a given UL (uplink) subframe, the control section determines a feedback timing of the transmission acknowledgement signal in accordance with the LBT result in a UL subframe prior to the given UL subframe.

### Technical Advantage of the Invention

According to the present invention, it is possible to prevent deterioration in communication quality even when LBT applies to UL transmission.

### BRIEF DESCRIPTION OF THE DRAWINGS

FIG. 1 provides diagrams each illustrating an example of the LTE operation mode in the unlicensed band;

FIG. 2 is a diagram illustrating an example of the LTE operation in the unlicensed band;

FIG. 3 provides diagrams illustrating TDD UL/DL configurations and HARQ-ACK timing in each UL/DL configuration;

FIG. 4 provides diagrams explaining retransmission control when UL-LBT applies;

FIG. 5 is a diagram illustrating an example of the HARQ-ACK timing table in consideration of an LBT result;

FIG. 6 is a diagram illustrating an example of the HARQ-ACK feedback control in consideration of an LBT result;

FIG. 7 is a diagram illustrating another example of the HARQ-ACK feedback control in consideration of an LBT result;

FIG. 8 is a diagram illustrating an example of a radio frame configuration when LBT is performed;

FIG. 9 is a diagram illustrating an example of flowchart of HARQ-ACK feedback in consideration of an LBT result;

FIG. 10 is a diagram illustrating another example of the HARQ-ACK timing table in consideration of an LBT result;

FIG. 11 is a diagram illustrating another example of HARQ-ACK feedback control in consideration of an LBT result;

FIG. 12 is a diagram illustrating an example where HARQ-ACK timing coincides with a UL-LBT subframe;

FIG. 13 is a diagram illustrating an example of HARQ-ACK feedback control in consideration of a UL-LBT subframe;

FIG. 14 is a diagram illustrating another example of HARQ-ACK feedback control in consideration of a UL-LBT subframe;

FIG. 15 is a diagram illustrating another example of HARQ-ACK feedback control in consideration of an LBT result;

FIG. 16 is a diagram illustrating another example of HARQ-ACK feedback control in consideration of an LBT result;

FIG. 17 is a diagram illustrating another example of HARQ-ACK feedback control in consideration of an LBT result;

FIG. 18 is a diagram schematically illustrating a radio communication system according to the present embodiment;

FIG. 19 is a diagram for explaining the overall configuration of a radio base station according to the present embodiment;

FIG. 20 is a diagram for explaining a functional configuration of the radio base station according to the present embodiment;

FIG. 21 is a diagram for explaining the overall configuration of a user terminal according to the present embodiment; and

FIG. 22 is a diagram for explaining a functional configuration of the user terminal according to the present embodiment.

### DESCRIPTION OF EMBODIMENTS

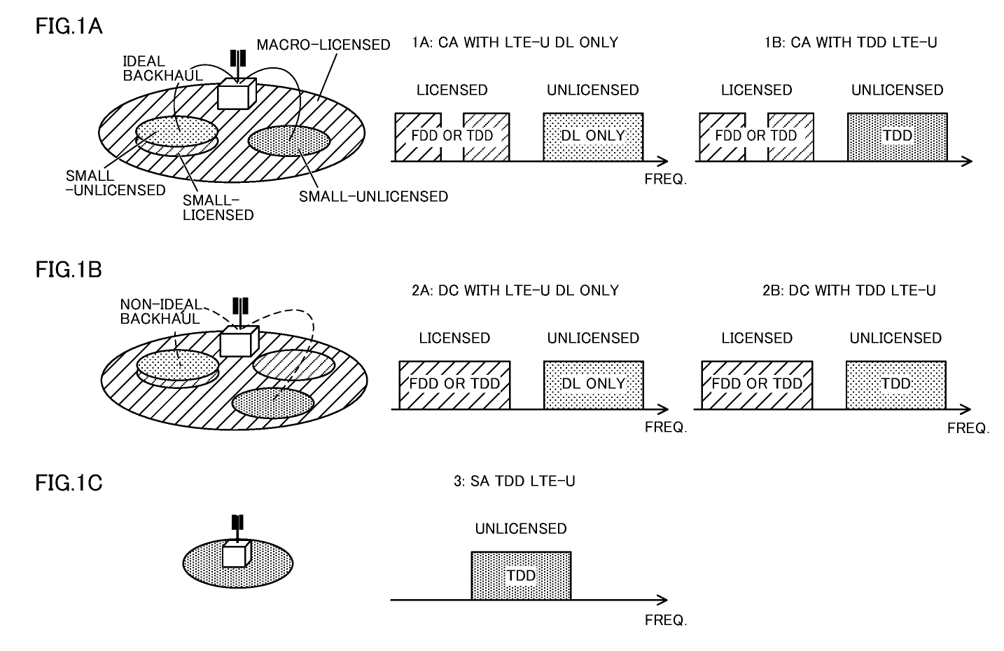

FIG. 1 provides diagrams illustrating an example of operation of a radio communication system operating LTE in the unlicensed band (LTE-U). As illustrated in FIG. 1, there are expected a plurality of scenarios for using LTE in unlicensed band, such as carrier aggregation (CA), dual connectivity (DC) and stand-alone (SA).

FIG. 1A illustrates a scenario in which carrier aggregation (CA) is applied using licensed and unlicensed bands. CA is a technique of aggregating a plurality of frequency blocks (also called “component carriers” (CCs) or cells) into a broad band. Each CC has a bandwidth of, for example, maximum 20 MHz and, for example, five CCs are aggregated into a broad band of maximum 100 MHz.

In the example illustrated in FIG. 1A, CA is applied to a macro cell and/or a small cell using the licensed band and a small cell using the unlicensed band. When CA applies, a scheduler of one radio base station is configured to control scheduling of a plurality of CCs. According, CA may be called intra-base station CA (intra-eNB CA).

In this case, the small cell using the unlicensed band may use a carrier dedicated for DL transmission (scenario 1A) or use TDD for UL transmission and DL transmission (scenario 1B). Here, in the licensed band, FDD and/or TDD may be used.

Further, it may be configured that the licensed and unlicensed bands are transmitted and received by one transmission/reception point (for example, radio base station) (Co-located). In this case, the transmission/reception point (for example, LTE/LTE-U base station) may perform communication with a user terminal by using both of the licensed band and the unlicensed band. Otherwise, it may be configured that the licensed band and the unlicensed band are transmitted and received by different transmission/reception points (for example, one is a radio base station and the other is an RRH (Remote Radio Head) connected to the radio base station) (non-co-located).

FIG. 1B illustrates a scenario in which dual connectivity (DC) is applied using the licensed and unlicensed bands. DC is identical to CA in that a plurality of CCs (or cells) are aggregated into a broad band. On the other hand, CA is based on the premise that CCs (or cells) are connected by ideal backhaul and coordinated control is possible with extremely small delay time, while DC is based on the premise that cells are connected by non-ideal backhaul with unignorable delay time.

Accordingly, in dual connectivity, cells are operated by different base stations and a user terminal performs communication by connecting to cells (or CCs) of different frequencies operated by different base stations. When dual connectivity applies, a plurality of schedulers are provided independently and each of the plural schedulers controls scheduling of one or more cells (CCs) managed by itself. Therefore, dual connectivity may be called inter-base station CA (inter-eNB CA). Here, in dual connectivity, carrier aggregation (intra-eNB CA) may be applied per scheduler (that is, base station) provided independently.

In the example illustrated in FIG. 1B, DC applies to the macro cell using the licensed band and the small cell using the unlicensed band. In this case, the small cell using the unlicensed band may use a carrier dedicated for DL transmission (scenario 2A) or use TDD for UL transmission and DL transmission (scenario 2B). Here, the macro cell using the licensed band may adopt FDD and/or TDD.

In the example illustrated in FIG. 1C, stand-alone is applied in which a cell operating LTE in the unlicensed band is configured to operate alone. This stand-alone means that communication with a terminal is able to be realized without application of CA or DC. In scenario 3, the unlicensed band may be used as a TDD band.

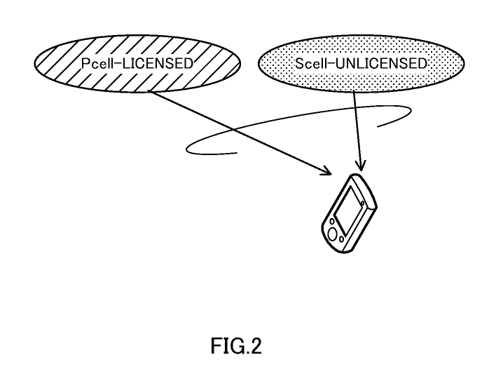

In addition, in the CA/DC operation mode illustrated in FIGS. 1A and 1B, for example, the licensed band CC (macro cell) may be used as a primary cell (PCell) and the unlicensed band CC (small cell) may be used as a secondary cell (SCell) (see FIG. 2). Here, the primary cell (PCell) is a cell for managing RRC connection and handover when performing CA/DL and is a cell that needs UL transmission for receiving data and feedback signals from terminals. The primary cell is always configured for both of uplink and downlink. The secondary cell (SCell) is a different cell that is configured in addition to the primary cell when CA/DC applies. The secondary cell may be configured only in downlink or may be configured simultaneously both in uplink and downlink.

As illustrated in FIG. 1A (CA) and FIG. 1B (DC) mentioned above, the mode assuming licensed band LTE (Licensed LTE) under operation of LTE-U is called LAA (Licensed-Assisted Access) or LAA-LTE. In LAA, the licensed band LTE and unlicensed band LTE cooperate with each other to communicate with a user terminal. In LAA, if a transmission point (e.g., radio base station) using the licensed band and a transmission point using the unlicensed band are far away from each other, they may be connected via the backhaul link (for example, optical fiber, X2 interface or the like).

Here, since the existing LTE is configured to operate with the licensed band, each operator is allocated with a different frequency band. However, the unlicensed band is not limited to specific carriers, unlike the licensed band. In LTE operation with the unlicensed band, the LTE may is operated between different operator systems and non-operator systems without synchronization, cooperation and/or coordination. In such a case, in the unlicensed band, multiple operators and systems are to share the same frequency, which may cause mutual interference.

Accordingly, in the Wi-Fi system operated in the licensed band, Carrier Sense Multiple Access/Collision Avoidance (CSMA/CA) based on the LBT (Listen Before Talk) mechanism has been adopted. Specifically, each transmission point (TP), access point (AP), Wi-Fi terminal (STA: Station) or the like is configured to perform listening (CCA: Clear Channel Assessment) before transmission and only if there is no signal exceeding a given level, then, it performs transmission. If there is a signal exceeding the given level, a stand-by time is provided randomly and after that, listening is performed again.

Then, in the LTE/LTE-A system operating with the unlicensed band (for example, LAA), transmission control with LBT (Listen Before Talk) has been studied like in the Wi-Fi system.

For example, the LTE-U base station and/or user terminal performs listening (LBT) before transmitting a signal in the unlicensed band and checks if another system (for example, Wi-Fi) or an LTE-U of another operator is in communication or not. As a result of listening, if there is no signal detected from the other system or LAA transmission point (LBT_idle), it performs signal transmission. On the other hand, if the listening results in detection of a signal from another system or another LAA transmission point (LBT_busy), the LTE-U base station and/or user terminal restricts its signal transmission. As for restriction on signal transmission, it may be realized by transition to another carrier by DFS (Dynamic Frequency Selection), performing transmission power control (TPC) or suspending signal transmission (standby).

Thus, with application of LBT to communication of the LTE/LTE-A system (for example, LAA) operating with the unlicensed band, it is possible to reduce interference with other systems and so on. However, the inventors have found that when LBT applies to the LTE/LTE-A communication, there may be deterioration of communication quality.

For example, assume that retransmission control (Hybrid ARQ) is adopted when LBT applies. In LTE/LTE-A, the user terminal transmits a transmission acknowledgement signal (called HARQ-ACK or A/N) in response to a downlink signal (for example, PDSCH) at a given timing. Specifically, when FDD applies, the user terminal feeds back HARQ-ACK 4 ms after receiving a DL signal. When TDD applies, the user terminal feeds back HAQ-ACK based on HARQ-ACK timing that is defined in advance for each UL/DL configuration.

Hence, also in the unlicensed band, the user terminal is expected to transmit a transmission acknowledgement signal for a downlink shared channel (PDSCH) by using an uplink control channel (PUCCH) and/or uplink shared channel (PUSCH) at a given timing.

However, when an LBT result shows that UL transmission is not enabled (LBT_busy), it becomes difficult to feed back a transmission acknowledgement signal appropriately at the HARQ-ACK(A/N) timing applied to the above-mentioned LTE-LTE-A (for example, licensed band). Then, the following description is made about the case in which in application of TDD (for example, the unlicensed band of the above-mentioned scenarios 1B, 2B or the like), HARQ-ACK timing defined in LTE/LTE-A is adopted.

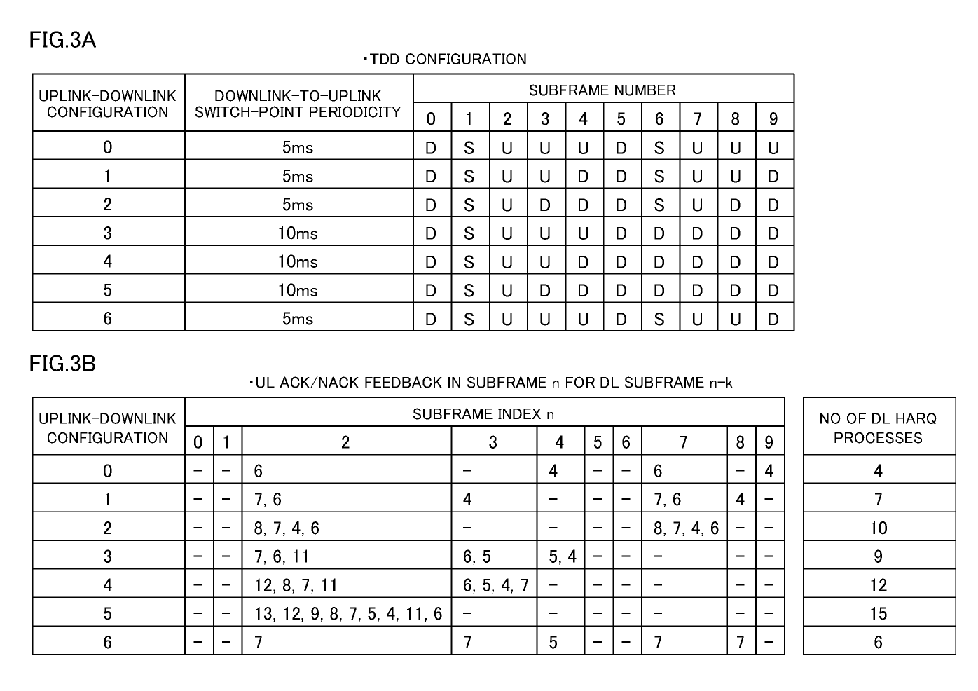

In TDD used in LTE/LTE-A, there are defined a plurality of frame configurations (UL/DL configurations) of different transmission ratios of UL and DL subframes (see FIG. 3A). In LTE/LTE-A until Rel. 11, there are seven frame configurations 0 to 6, in which subframes #0 and #5 are allocated to downlink and subframe #2 is allocated to uplink. Besides, in UL/DL configurations 0, 1, 2 and 6, change from DL subframe to UL subframe occurs at intervals of 5 ms, and in UL/DL configurations 3, 4 and 5, change from DL subframe to UL subframe occurs at intervals of 10 ms.

Further, in every UL/DL configuration, there is defined DL subframe/special subframe corresponding to a transmission acknowledgement signal (HARQ-ACK) to feed back in UL subframe (see FIG. 3B). Specifically, in the table of FIG. 3B, there are defined DL subframe/special subframe indexes each corresponding to a transmission acknowledgement signal to feed back in a UL subframe. More specifically, when each UL/DL configuration is set, the user terminal transmits a transmission acknowledgement signal for a downlink shared channel (PDSCH) received in the DL subframe/special subframe of subframe index n-k by using the UL subframe of subframe index n. Here, “k” is the index mentioned in the table of FIG. 3B. For example, in the case of UL/DL configuration 1 in FIG. 3B, the UL subframes of subframe indexes 2 and 7 are used to transmit transmission acknowledgement signals for downlink shared channels (PDSCH) received in DL subframes/special subframes of subframe indexes 5, 6 and 0, 1.

Here, in LTE, in order to avoid processing delay due to the HARQ synthesizing and retransmission process, a plurality of different HARQ processes (LD HARQ processes) are able to be performed independently and in parallel. The user terminal is able to divide a data buffer memory by the number of maximum HARQ processes (No of DL HARQ processes) and to buffer reception data in a different HARQ process memory in accordance with the HARQ process number corresponding to the reception data and apply HARQ. Here, information on which HARQ process number the reception data corresponds to is transmitted by a scheduling control signal (PDCCH) to allocate PDSCH. The number of HARQ processes depends on the time until the same HARQ process number can be reused (HARQ Round Trip Time, time until a transmission acknowledgement signal is received and a determination OK is detected). Accordingly, in TDD, the maximum HARQ process number varies with the UL/DL configuration. For example, if UL/DL configuration 5 applies, the maximum HARQ process number becomes 15.

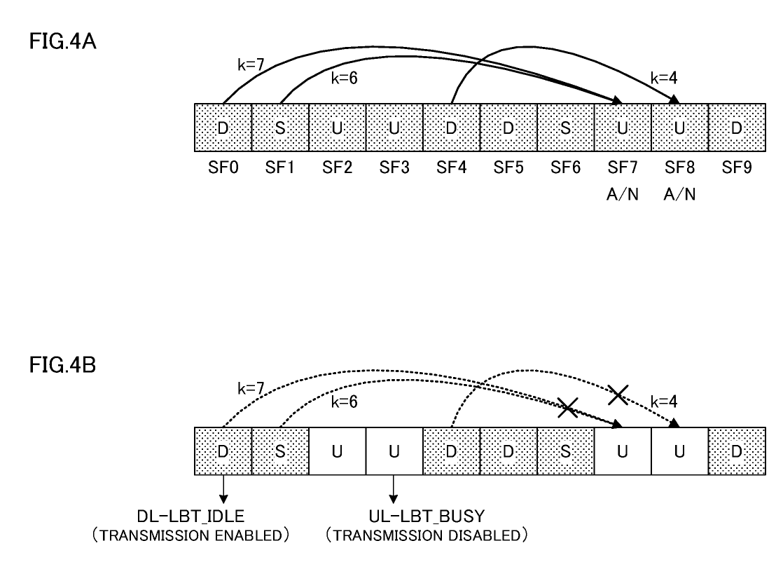

For example, in UL/DL configuration 1, UL subframe SF #2 is used to transmit transmission acknowledgement signals corresponding to DL subframe/special subframes 5-subframe and 7-subframe before the subframe SF #2. In addition, UL subframe SF #7 is also used like UL subframe SF #2. Then, UL subframe SF #8 is used to feed back a transmission acknowledgement signal for a DL subframe 4-subframe before the subframe SF #8 (see FIG. 4A).

However, as described above, when UL-LBT applies, there may be a case where UL subframe is not able to be used depending on an LBT result (LBT_busy). In such a case, the user terminal is not able to feed back HARQ-ACK at the timing as defined in advance in FIG. 3B. For example, when UL/DL configuration 1 applies and the UL-LBT result is LTE_busy, the user terminal is not able to perform transmission in UL subframes (a part or all of SF #2, #3, #7, #8) and is not able to feed back transmission acknowledgement signals appropriately (see FIG. 4B). This may cause deterioration in communication quality.

Then, the present inventors have found that when LBT is applied in UL, the feedback timing of a transmission acknowledgement signal is controlled in consideration of the LBT result, thereby enabling appropriate feedback of a transmission acknowledgement signal even with application of the LBT (for example, even when UL transmission is restricted).

For example, when the LBT result shows the UL subframe is not available for a given period (for example, during the LBT period), the feedback timing of the transmission acknowledgement signal is controlled to be delayed (Pending). In addition, when feedback of a transmission acknowledgement signal is not enabled in the UL subframe where LBT is performed (LBT subframe), the feedback timing of the transmission acknowledgement signal is controlled to be delayed.

With reference to the drawings, the present embodiment is described in detail below. In the following description, assume that LBT is applied to TDD UL, but it is not intended to limit the present invention. The following configuration may be applied to a control method of a transmission acknowledgement signal (HARQ-ACK, A/N) when signal transmission is restricted by LBT.

### First Embodiment

The first embodiment is described assuming when the LBT result shows UL transmission is restricted in the user terminal (LBT_busy), a transmission acknowledgement signal to allocate to the transmission-restricted UL subframe is delayed by a given timing and transmitted. In the following description, LBT is performed on a per given radio frame basis, more specifically, with the LBT periodicity of 5 ms or 10 ms, which, however, is not intended to limit the present invention.

(The Case where LBT Periodicity=5 ms)

When the LBT periodicity is a half of the radio frame (10 subframes), the user terminal and/or radio base station controls the HARQ-ACK feedback based on the LBT result per half radio frame. When the UL-LBT result is LBT_idle and HARQ-ACK is to be fed back, the user terminal and/or radio base station takes into consideration an LBT result of a half radio frame before the half radio frame where a UL subframe to transmit HARQ-ACK (to allocate HARQ-ACK) is arranged. Here, depending on the LBT periodicity as configured, it may consider an LBT result of a UL subframe before the UL subframe of LBT_idle.

For example, when the UL-LBT result shows that a UL subframe in the N-th half radio frame N is available (LBT_idle/LBT_available), the user terminal and/or radio base station controls retransmission (HARQ-ACK timing or the like) in consideration of an LBT result of the last half radio frame N−1 before the half radio frame N.

When the half radio frame N is LBT_idle and the half radio frame N−1 is also LBT_idle, the use terminal is able to use HARQ-ACK timing in the existing LTE/LTE-A. For example, the HARQ-ACK timing in the half radio frame N may be the HARQ-ACK timing defined in a TDD UL/DL configuration to apply to communication or DL-reference UL/DL configuration for defining the HARQ-ACK timing.

Here, the DL-reference UL/DL configuration is a UL/DL configuration for referring to the DL HARQ-ACK timing. The DL reference UL/DL configuration defines the DL HARQ-ACK transmission timing and may be different from the UL/DL configuration actually used in communication. In addition, it may be also different from the UL-reference UL/DL configuration defining the UL HARQ-ACK transmission timing. These may be used in dynamic TDD (eIMTA) for changing the UL/DL configuration dynamically in the time direction in the same serving cell or inter-band TDD carrier aggregation by aggregating a plurality of bands of different UL/DL configurations (or serving cells) for communication.

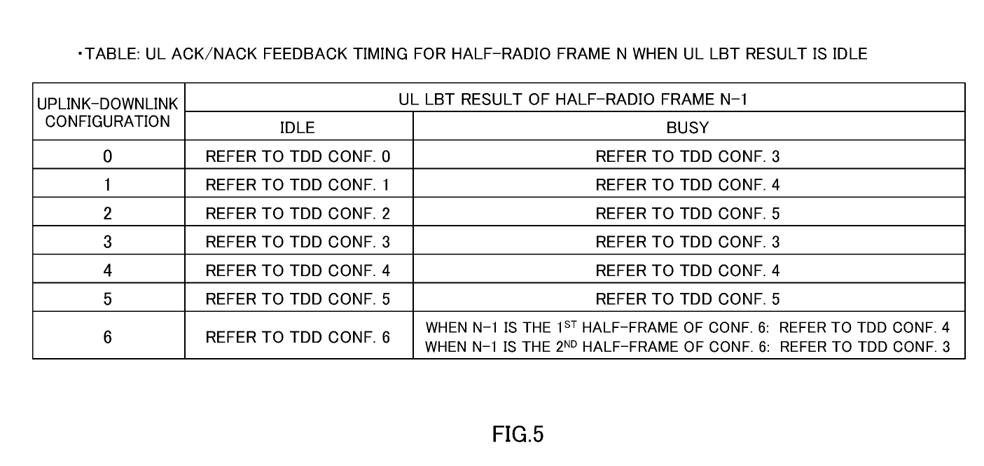

On the other hand, when the half radio frame N is LBT_idle and the half radio frame N−1 is LBT_busy, the use terminal changes the HARQ-ACK timing in the half radio frame N in the given UL/DL configuration. That is, the user terminal changes HARQ-ACK to allocate to the UL subframe in the half radio frame N to feed it back (see FIG. 5). The given UL/DL configuration may be UL/DL configurations 0, 1, 2 or 6 in which the UL-DL switching configuration is 5 ms.

That is, when the UL/DL configurations 0, 1, 2 and 6 are employed, the user terminal changes the UL/DL configuration to apply to the HARQ-ACK timing in the half radio frame N. The different UL/DL configuration may be UL/DL configuration 3, 4 or 5 of which the DL-UL switching configuration is 10 ms. As a modification example of the UL/DL configuration, all subframes in the half radio frame N−1 of LBT_busy are replaced with DL subframes and a UL/DL configuration corresponding to combination of the half radio frame N−1 and the half radio frame N may be selected.

For example, when the UL/DL configuration 0 is employed, if the half radio frame N−1 is LBT_busy and the half radio frame N is LBT_idle, the HARQ-ACK timing of the UL/DL configuration 3 is applied in the half radio frame N. With this configuration, HARQ-ACK that is not able to be transmitted in UL subframe of the half radio frame N−1 (HARQ-ACK of DL subframe before the half radio frame N−2) is able to be delayed and transmitted in a UL subframe in the half radio frame N appropriately.

Further, when the UL/DL configuration 1 is used, it may be changed to the UL/DL configuration 4, and when the UL/DL configuration 2 is used, it may be changed the UL/DL configuration 5 (see FIG. 5). In the example shown in FIG. 5, the UL/DL configuration before change and the UL/DL configuration after change have the same UL/DL configuration in the first-half five subframes (assuming that a special subframe is a DL subframe). Thus, as the configuration having the same UL/DL arrangement in the first-half five subframes as the UL/DL configuration before change is selected as the UL/DL configuration after change, it is possible to control the HARQ-ACK feedback appropriately.

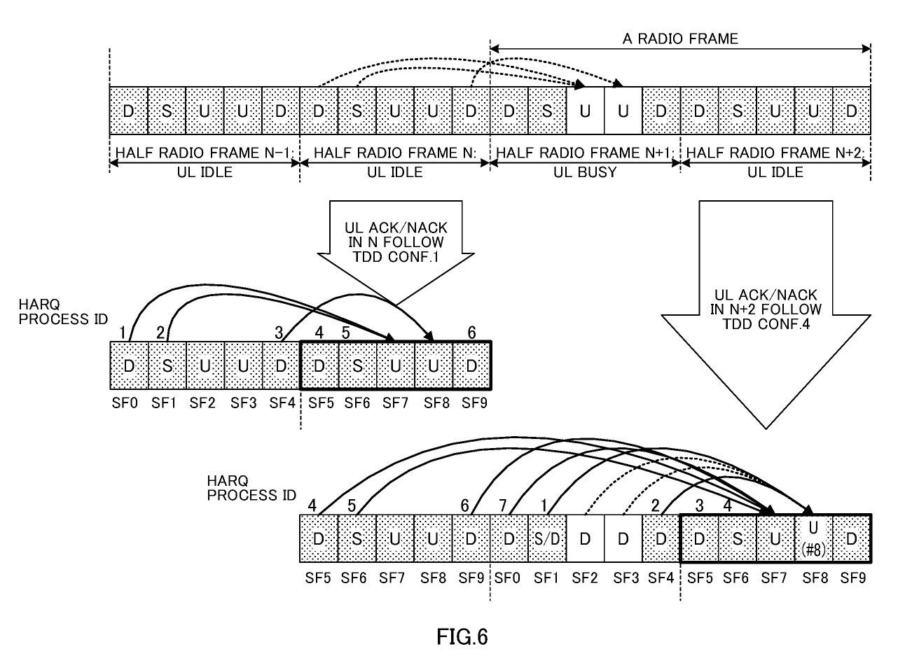

FIG. 6 illustrates the HARQ-ACK timing when the LBT periodicity is 5 ms in TDD with the UL/DL configuration 1. FIG. 6 shows HARQ-ACK timing in two radio frames (four half radio frames). Here, a UL subframe is available in the half radio frames N−1, N, N+2 (LBT_idle), while no UL subframe is available in the half radio frame N+1 (LBT_busy).

Since the UL-LBT result in the half radio frame N shows LBT_idle, the user terminal and/or radio base station controls HARQ-ACK feedback in consideration of the LBT result of the last half radio frame N−1. In this example, since the LBT result of the half radio frame N−1 also shows LBT_idle, the HARQ-ACK timing of the UL/DL configuration 1 is used. That is, A/Ns corresponding to the DL subframe 0 and the special subframe 1 arranged in the half radio frame N−1 are fed back in the UL subframe 7 arranged in the half radio frame N. In addition, an A/N corresponding to the DL subframe 4 is fed back in the UL subframe 8 arranged in the half radio frame N.

Since the UL-LBT result in the half radio frame N+1 shows LBT_busy, the UL subframe is not able to be used. In this case, A/Ns corresponding to DL/special subframes in the half radio frames before the half radio frame N+1 are not able to be fed back in the UL subframe of the half radio frame N+1.

Since the UL-LBT result in the half radio frame N+2 shows LBT_idle, the user terminal and/or radio base station controls HARQ-ACK feedback in consideration of the LBT result of the last half radio frame N+1 before the half radio frame N+2. Here, since the LBT in the half radio frame N+1 results in LBT_busy, the user terminal changes HARQ-ACK to allocate to the UL subframe in the half radio frame N+2 and controls feedback. For example, the user terminal refers to the table in FIG. 5 and applies the HARQ-ACK timing of the UL/DL configuration 4 to the UL subframe in the half radio frame N+2.

In this case, the use terminal performs HARQ-ACK feedback of the half radio frame N+2 assuming that subframes in the half radio frame N+1 are “DDDD”. That is, the user terminal feeds back HARQ-ACKs corresponding to DL subframe 5, special subframe 6 and DL subframe 9 arranged in the half radio frame N and DL subframe 0 arranged in the half radio frame N+1 by using UL subframe 7 arranged in the half radio frame N+2. The user terminal feeds back HARQ-ACKs corresponding to special subframe 1 and DL subframe 4 arranged in the half radio frame N+1 by using the UL subframe 8 arranged in the half radio frame N+2.

Here, even when UL/DL configuration 4 is applied as the HARQ-ACK timing after change, the radio base station and the user terminal are able to know that there is no HARQ-ACK in DL subframes 2, 3 in the half radio frame N+1 of LBT_busy. That is, the radio base station and the user terminal are able to operate by recognizing that there are a less number of HARQ-ACKs to feed back in UL subframe 8 of the half radio frame N+2 (4→2).

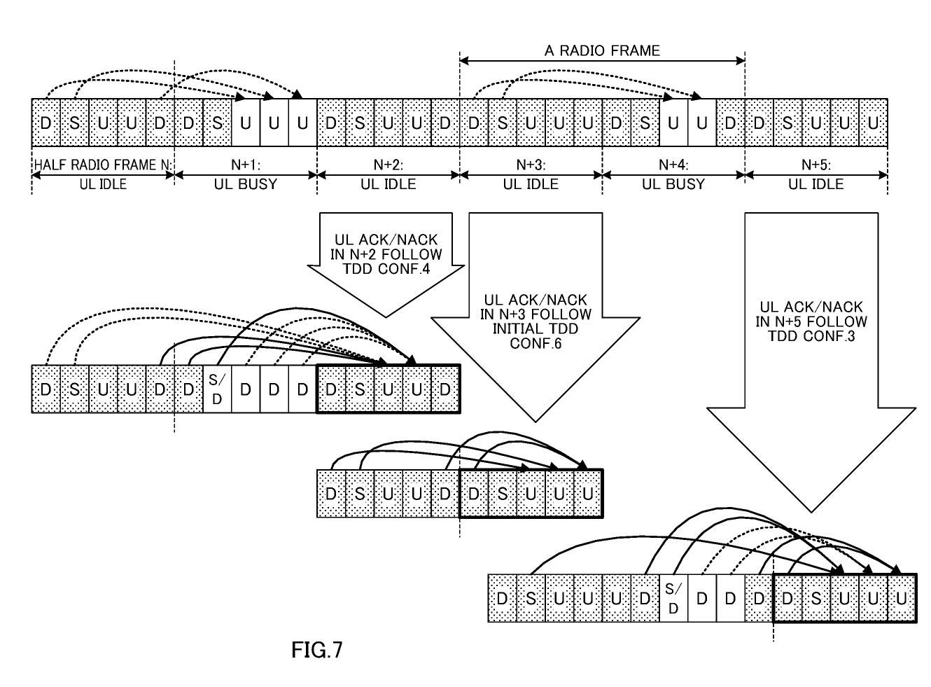

FIG. 7 illustrates an example of HARQ-ACK timing when LBT periodicity is 5 ms in TDD with UL/DL configuration 6. Here, UL subframes are available in the half radio frames N, N+2, N+3, N+5 (LBT_idle), while no UL subframe is available in the half radio frames N+1, N+4 (LBT_busy).

In the example shown in FIG. 7, when the given half radio frame is LBT_idle and the last half radio frame before the given half radio frame is LBT_busy, a UL/DL configuration different from the UL/DL configuration 6 is employed (referred to) as the HARQ-ACK timing. As for the different UL/DL configuration from the UL/DL configuration 6, if the half radio frame of LBT_busy is the first half frame (1^{st} half-frame), the HARQ-ACK timing of UL/DL configuration 4 is used. In addition, the half radio frame of LBT_busy is the second half radio frame (2^{nd} half-frame), the HARQ-ACK timin of the U/DL configuration 3 is used.

In FIG. 7, as the half radio frame N+1 (1^{st} half-frame) is LBT_busy, in the half radio frame N+2, the HARQ-ACK timing of the UL/DL configuration 4 is used to control HARQ-ACK allocation to the UL subframe. In addition, as the half radio frame N+2 is LBT_idle, in the half radio frame N+3, the HARQ-ACK timing of the UL/DL configuration 6 is used. Further, as the half radio frame N+4 (2^{nd} half-frame) is LBT_busy, in the half radio frame N+5, the HARQ-ACK timing of the UL/DL configuration 3 is used.

Thus, when feeding back HARQ-ACK by using the given UL/DL configuration, the user terminal is able to control the UL/DL configuration to apply to the HARQ-ACK timing based on the LBT result of at least one before the half radio frame (the last half radio frame) (or UL subframe). With this configuration, even when UL_LBT is applied, the user terminal is able to feed back HARQ-ACK to the radio base station appropriately.

### <UE/eNB Operation>

The user terminal obtains, from the radio base station, information about UL/DL configuration (DL-reference UL/DL configuration) defining HARQ-ACK timing and/or TDD UL/DL configuration to apply to communication. DL-reference UL/DL configuration is UL/DL configuration that is used in HARQ-ACK feedback timing in dynamic TDD (also called eIMTA) in which UL/DL configuration changes.

In addition, the user terminal obtains information about LBT (for example, information of LBT subframes and/or LBT s or the like). The information about the UL/DL configuration and the information about LBT may be obtained by using higher layer signaling such as a broadcast signal (for example, SIB (System Information Block)), RRC signaling or the like.

The position of an LBT subframe (or LBT symbol) may be configured to be determined in association with the TDD UL/DL configuration. For example, the UL-LBT may be configured to be performed in a special subframe. With this structure, it is possible to reduce overhead of higher layer signaling to the user terminal.

Otherwise, the position of the LBT subframe (or LBT symbol) may be configured independently from the TDD UL/DL configuration. In this case, it is possible to differentiate the position of the LBT subframe between serving cells of neighbor base stations or change the UL/DL configuration, thereby increasing the operation flexibility.

The user terminal performs HARQ feedback control in accordance with the LBT result based on the obtained information (for example, UL/DL configuration, DL-reference UL/DL configuration or the like). At this time, the user terminal is able to hold a table illustrated in FIG. 5 explained above and control HARQ-ACK feedback based on the table. In the table shown in FIG. 5, the UL/DL configuration to use for HARQ-ACK timing is defined corresponding to each UL/DL configuration (or DL-reference UL/DL configuration). In addition, the UL/DL configuration to apply to HARQ-ACK timing may be defined based on the LBT result (LBT_idle and LBT_busy) of the last LBT periodicity (for example, the last half radio frame).

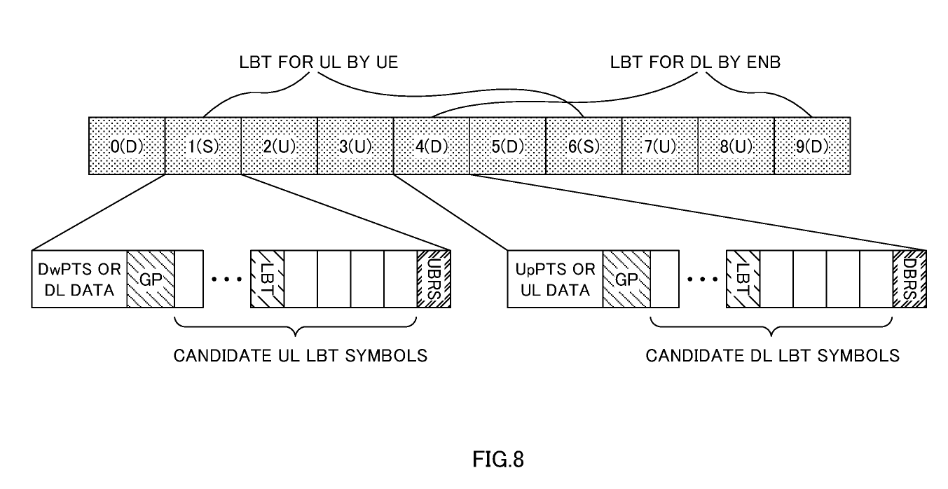

FIG. 8 illustrates a radio frame configuration of which the LBT periodicity (LBT subframe or LBT symbol allocation cycle) is 5 ms. In this example, the UL/DL configuration 1 is applied, and the user terminal performs UL-LBT in subframes 1 and 6 of special subframes and the radio base station performs DL-LBT in subframes 4 and 9.

The radio base station performs LBT in a DL-LBT subframe (or LBT symbol). If the LBT result shows detection of another signal and LBT_busy, DL transmission is restricted until the next DL-LBT occasion after performing DL-LBT (for example, the radio base station refrains from DL transmission that exceeds a given channel occupation rate or transmission power). On the other hand, if the LBT result shows LBT_idle, DL transmission is performed without restricting the transmission until the next DL-LBT occasion after DL-LBT is performed.

In addition, when determining that it is LBT_idle, the radio base station is able to transmit a beacon signal (BRS: Beacon RS) by using an available resource before a resource to perform DL transmission (DL transmission resource). By signaling (declaring) channel occupation to another radio base station or the like with use of BRS in DL (DL-BRS), the radio base station is able to inform neighbor radio base stations that it is LBT_busy. In addition, by transmitting BRS, the radio base station is able to inform the reception side (user terminal) that the LBT result of the connecting radio base station is LBT_idle. When detecting the BRS from the connecting radio base station, the user terminal is able to prepare for DL reception in following DL resources. The configuration of the beacon signal, resource information or message included in the beacon signal may be used to inform the user terminal having detected the beacon signal of control information in following DL transmission resources, transmission power information and the like. In this case, as the control information to transmit in the following DL transmission resource is able to be included and transmitted in the beacon signal in advance, it is possible to reduce overhead of the control signal in the DL transmission resource.

The user terminal performs LBT in a UL-LBT subframe (or LBT symbol). If the LBT result shows detection of another signal and LBT_busy, UL transmission is restricted until the next UL-LBT occasion after performing UL-LBT (for example, the user terminal refrains from UL transmission that exceeds a given channel occupation rate or transmission power). On the other hand, if the LBT result shows LBT_idle, UL transmission is performed, without restricting the transmission, until the next UL-LBT occasion after UL-LBT.

In addition, when determining that it is LBT_idle, the user terminal is able to transmit a beacon signal (BRS: Beacon RS) by using an available resource before a resource to perform UL transmission (UL transmission resource). By signaling (declaring) channel occupation to another user terminal and/or another radio base station or the like with use of BRS in UL (UL-BRS), the user terminal is able to inform neighbor user terminals and/or radio base stations that it is LBT_busy. In addition, the user terminal is able to inform the reception side (radio base station) that the LBT result of the user terminal is LBT_idle. When detecting the BRS from the user terminal, the radio base station is able to prepare for UL reception in following UL resources. The beacon signal configuration, resource information or a message included in the beacon signal may be used to inform the radio base station having detected the BRS of control information in following UL transmission resources, transmission power information or control information about DL reception data and the like. In this case, as the control information to transmit in the following UL transmission resource is able to be included and transmitted in the beacon signal in advance, it is possible to reduce overhead of the control signal in the UL transmission resource.

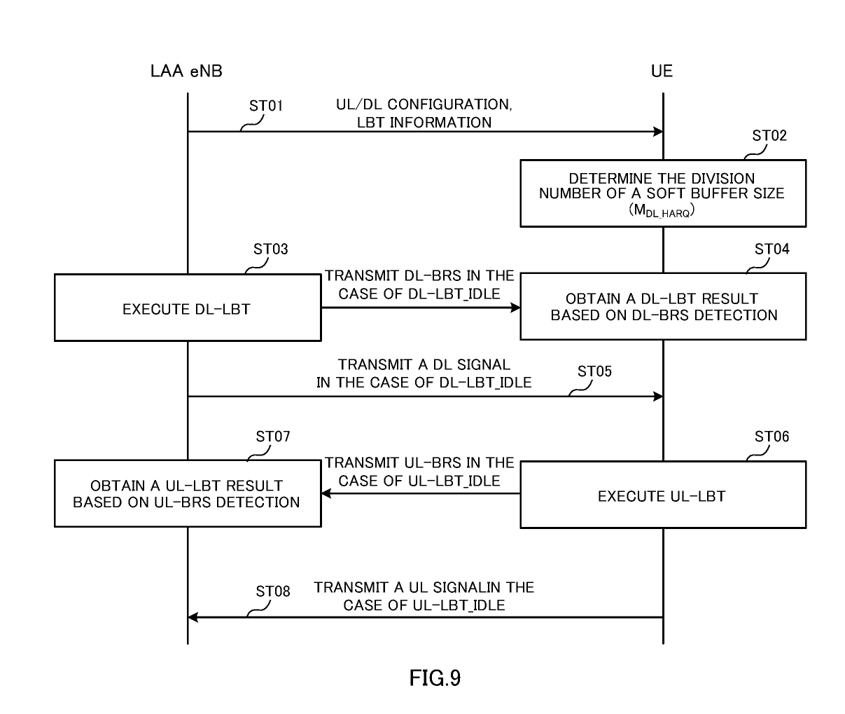

FIG. 9 illustrates an example of flowchart according to the present embodiment.

First, the radio bae station (for example, LAA eNB) transmits information about the TDD UL/DL configuration and information about LBT to the user terminal by higher layer signaling (for example, a broadcast signal, RRC signaling or the like) (ST01). The information about the TDD UL/DL configuration may be UL/DL configuration to apply to communication and/or reference UL/DL configuration to apply to the HARQ-ACK timing when dynamic TDD (eIMTA) is applied. In addition, the information about LBT may be at least one of a subframe to perform the LBT, a LBT symbol and LBT periodicity.

Further, the UL/DL configuration for HARQ-ACK feedback which the user terminal applies in accordance with the LBT result may be transmitted to the use terminal. Otherwise, the user terminal may hold a table in which UL/DL configurations for HARQ-ACK feedback to apply in accordance with the LBT result (see FIG. 5). In this case, the user terminal and the radio base station may have the common table.

The user terminal determines the division number of a soft buffer size (ST02). For example, the use terminal determines the soft buffer size in consideration of the number of HARQ processes in a UL/DL configuration to apply in the LBT_idle case and the number of HARQ processes in a UL/DL configuration to change and apply in the LBT_busy case. For example, the user terminal may determine the division number of the soft buffer size based on the HARQ processes that becomes maximum in applicable HARQ-ACK timings (for example, UL/DL configurations).

The radio base station performs DL-LBT at a given timing (ST03). In addition, the radio base station may transmit a BRS when determining the LBT result is idle. Receiving a DL-BRS transmitted from the radio base station, the user terminal may recognize the DL-LBT result (LBT_idle) and prepare for reception of a DL signal (ST04). Further, the radio base station transmits the DL signal when the DL-LBT result is idle (ST05).

The user terminal performs UL-LBT at a given timing (ST06). In addition, the user terminal may transmit BRS when determining the LBT result is idle. When receiving the UL-BRS transmitted from the user terminal, the radio base station is able to recognize the UL-LBT result (LBT_idle) and prepare for reception of a UL signal (ST07). Further, the user terminal transmits the UL signal when the UL-LBT result is idle (ST08).

When transmitting the UL signal, the user terminal controls HARQ-ACK feedback corresponding to the received DL signal based on the UL-LBT result. Specifically, as illustrated in FIGS. 6 and 7, when a given half radio frame N is LBT_idle, the user terminal controls the HARQ-ACK feedback in consideration of the LBT result of the half radio frame N−1 before the half radio frame N.

The radio base station detects a HARQ-ACK transmitted from the user terminal. The radio base station is able to recognize the LBT result (LBT_idle) determined by the user terminal, in accordance with whether UL-BRS from the user terminal is detected or not. Hence, the radio base station is able to perform detection while understanding the HARQ-ACK timing appropriately. When the HARQ-ACK transmitted from the use terminal results in “ACK” the radio base station performs next data transmission (new data transmission) and when the HARQ-ACK results in “NACK”, the radio base station performs retransmission.

(The Case where LBT Periodicity=10 ms)

When the LBT periodicity is 10 ms that is equal to the radio frame (10 subframes), the user terminal and/or the radio base station controls HARQ-ACK feedback based on the LBT result per radio frame (half-radio frame). When the UL-LBT result is LBT_idle and HARQ-ACK is to be fed back, the user terminal and/or the radio base station takes into consideration the LBT result of a radio frame before the radio frame where UL subframe to transmit the HARQ-ACK (to allocate the HARQ-ACK) is allocated.

For example, when the radio frame M is LBT_idle and the radio frame M−1 is also LBT_idle, the HARQ-ACK timing to apply to the radio frame M may be the timing defined in the TDD UL/DL configuration to apply to communication or timing defined in the UL/DL configuration for defining the HARQ-ACK timing (DL-reference UL/DL configuration).

On the other hand, when the radio frame M is LBT_idle and the radio frame M−1 is LBT_busy, in a given UL/DL configuration, the HARQ-ACK timing in the radio frame M (HARQ-ACK to allocate to the UL subframe in the radio frame M) is changed. Specifically, when using the UL/DL configuration 0, 1, 2 or 6 (the UL-DL switching configuration is 5 ms), the first-half frame (1st half frame) and the second-half frame (2nd half frame) in the radio frame M may employ mutually different HARQ-ACK timings.

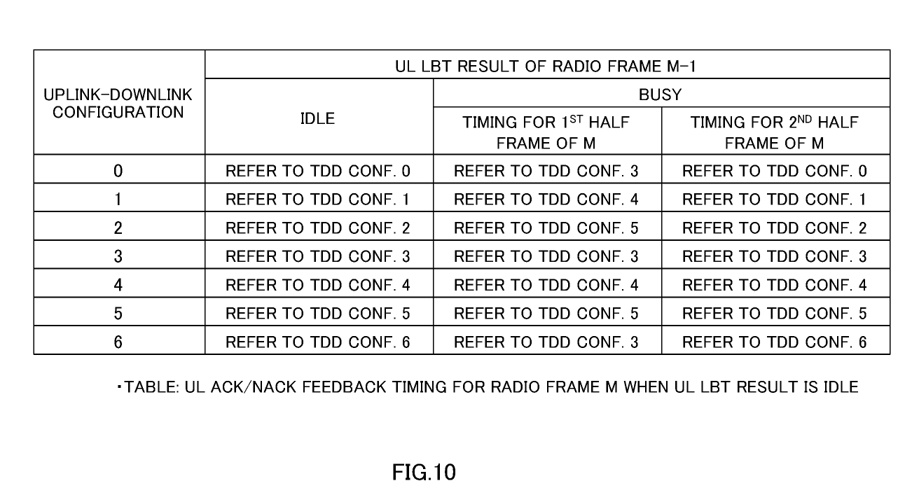

Specifically, the HARQ-ACK timing to use in the first half frame (subframes 0-4) of the radio frame M is changed to the timing of another UL/DL configuration (see FIG. 10). In this case, assuming that all of second half frame of the radio frame M−1 of LBT_busy are DL subframes, a UL/DL configuration for combination of the second half frame of the radio frame M−1 and the first half frame of the radio frame M may be used. The different UL/DL configuration after change may be UL/DL configuration 3, 4 or 5 of which the DL-UL switching configuration is 10 ms.

For example, when using the UL/DL configuration 0, if the radio frame M−1 is LBT_busy and the radio frame M is LBT_idle, the HARQ-ACK feedback timing of the UL/DL configuration 3 is applied in the first half frame of the radio frame M (see FIG. 10). In this case, HARQ-ACK that is not able to be transmitted in the UL subframe of the radio frame M−1 is delayed and transmitted in the UL subframe of the radio frame M. On the other hand, in the second half frame of the radio frame M, the HARQ-ACK timing to use in the UL/DL configuration 0 is used to control the HARQ-ACK feedback.

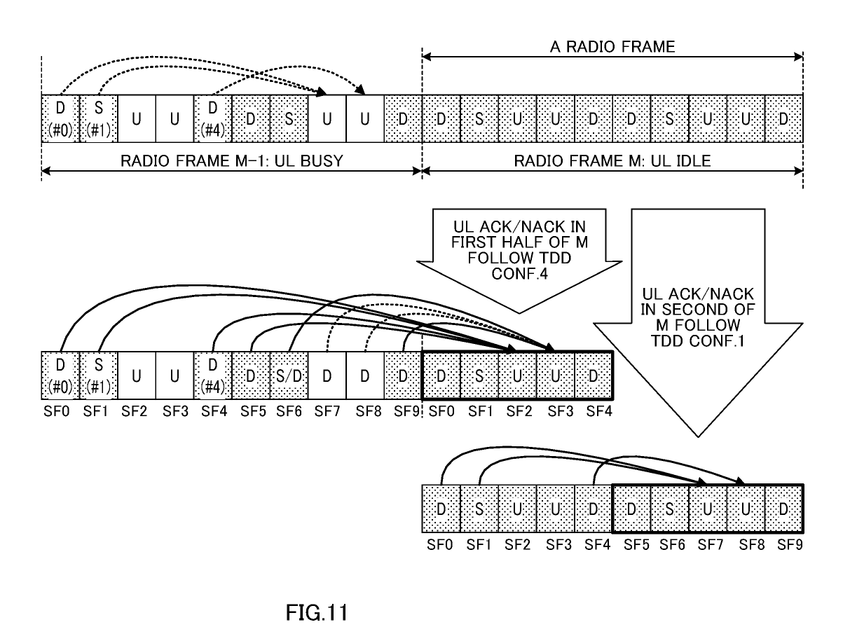

FIG. 11 illustrates an example of the HARQ-ACK feedback timing when the UL/DL configuration 1 applies and the LBT periodicity is 10 ms. FIG. 11 shows the HARQ-ACK feedback method in two radio frames. Here, in the radio frame M, a UL subframe is available (LBT_idle) and in the radio frame M−1, no UL subframe is available (LBT_busy).

Since the UL-LBT result in the radio frame M is LBT_idle, the user terminal and/or the radio base station controls HARQ-ACK feedback in consideration of the LBT result of the last radio frame M−1. Here, as the LBT result of the radio frame M is LBT_busy, the UL subframe is not able to be used.

Accordingly, in the radio frame M (for example, in the first half frame of the radio frame M), the HARQ-ACK timing of the given UL/DL configuration (HARQ-ACK to allocate to the UL subframe) is changed. For example, as illustrated in FIG. 10, when UL/DL configuration 1 applies, the HARQ-ACK timing to apply to the TDD UL/DL configuration 4 in the first half frame of the radio frame M is used.

Here, HARQ-ACK feedback in the radio frame M is controlled assuming that subframes in the second half frame (2nd half frame) in the radio frame M−1 are downlink subframes (DDDDD). With this control, HARQ-ACKs corresponding to the DL subframes 0, 4 and 5 and special subframe 1 allocated in the radio frame M−1 are able to be fed back in the UL subframe 2 allocated in the radio frame M. That is, under normal circumstances (where the radio frame M−1 is LBT_idle), the HARQ-ACK to feed back in the UL subframe 7 of the radio frame M−1 is delayed and fed back in the UL subframe of the radio frame M.

In addition, in the second half frame of the radio frame M that is LBT_idle, the HARQ-ACK timing of the UL/DL configuration 1 is used.

Here, the radio base station and the user terminal are able to know that there is no HARQ-ACK corresponding to DL subframes 7, 8 o the radio frame N−1 that is LBT_busy even when the UL/DL configuration 4 is applied as the HARQ-ACK timing after change. That is, the radio base station and the user terminal are able to operate by recognizing that there is a less number of HARQ-ACKs to feed back in the UL subframe 3 in the radio frame M (4→2).

### Second Embodiment

In the second embodiment, description is made of the HARQ-ACK feedback control when the UL subframe to feed back an HARQ-ACK (to allocate HARQ-ACK) becomes an LBT subframe, that is, when the HARQ-ACK timing coincides with the LBT subframe.

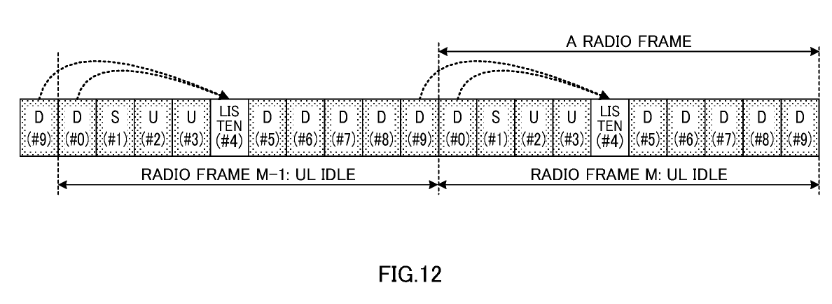

Considering its circuitry, the radio communication terminal or the radio base station has difficulty in performing transmission and reception simultaneously at the same time and with the same frequency. Accordingly, when performing UL LBT, the user terminal may be not able to perform HARQ-ACK feedback in the LBT subframe for performing LBT. FIG. 12 illustrates an example of HARQ-ACK feedback when the LBT periodicity (the period for performing LBT) is 10 ms in TDD with UL/DL configuration 3.

Here, it is assumed that UL LBT is performed in the subframe 4 (UL subframe) of each radio frame. In this case, when this UL subframe is used to perform the LBT operation (setting up of the listening period, UL-BRS transmission and so on), there may be restriction on the HARQ-ACK feedback.

In addition, as illustrated in the first embodiment above, even when the UL/DL configuration to apply to the HARQ-ACK feedback is changed based on the LBT result, the same problem arises if the UL subframe after change is the LBT subframe.

Then, in the second embodiment, when the HARQ-ACK timing overlaps the UL LBT subframe, the HARQ-ACK timing is controlled to be changed. For example, the user terminal controls to delay the HARQ-ACK overlapping the LBT subframe until a following available UL subframe and feed it back.

Further, when there is change in the UL/DL configuration to apply to the HARQ-ACK feedback based on the LBT result and a UL subframe after change is an LBT subframe, the user terminal is able to further delay the HARQ-ACK until a next available UL subframe to feed it back. In this case, the user terminal first controls the HARQ-ACK timing based on the LBT result (first embodiment) and controls the HARQ-ACK timing again when the HARQ-ACK timing coincides UL LBT subframe.

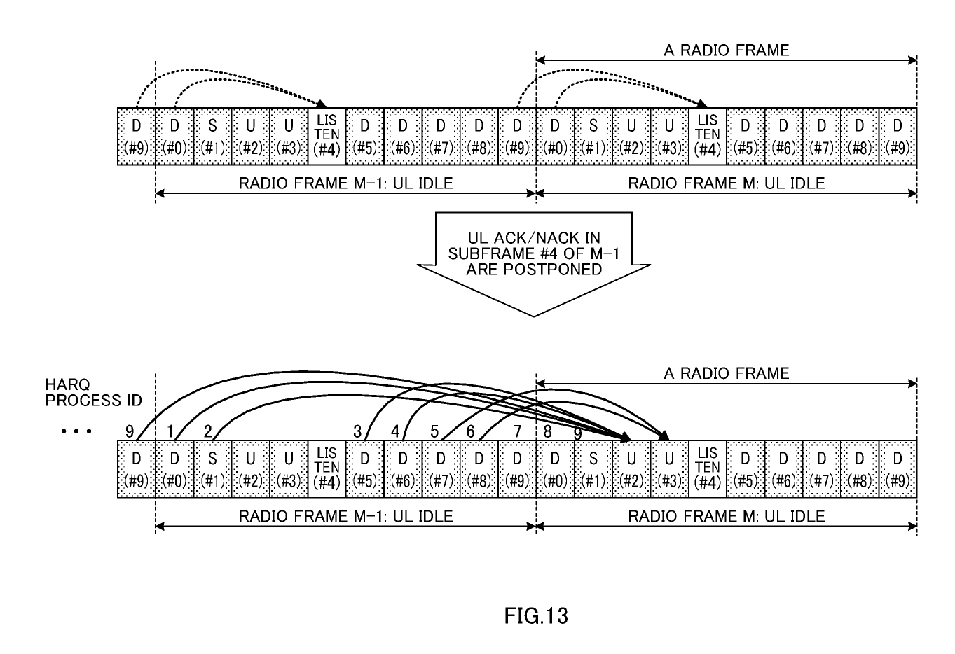

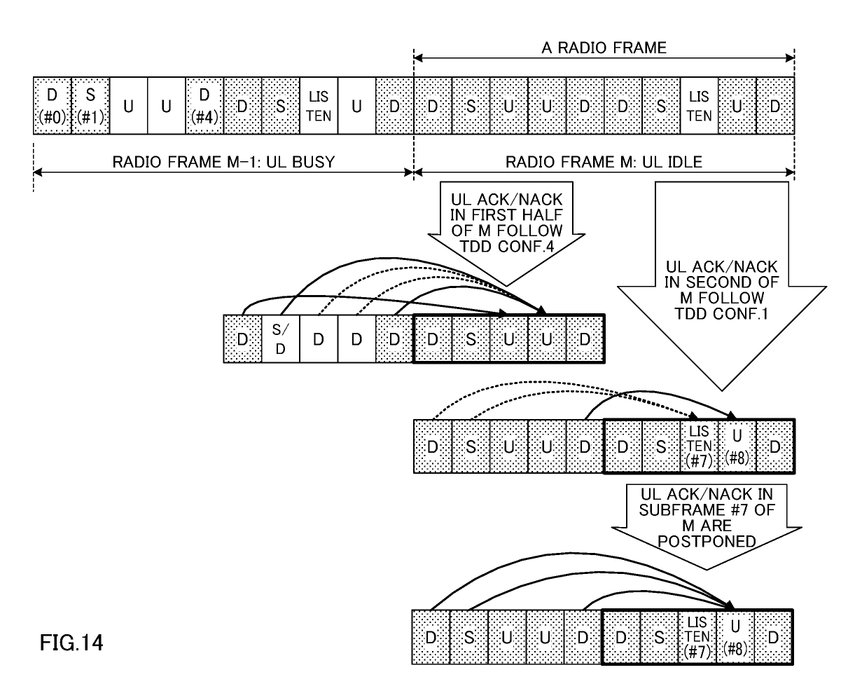

FIGS. 13 and 14 illustrate HARQ-ACK feedback timing in the present embodiment.

In FIG. 13, the LBT periodicity is 10 ms (subframe 4 is the UL LBT subframe), and the UL/DL configuration 3 is used. As the LBT results of radio frames M−1, M are LBT_idle, the user terminal applies the HARQ-ACK timing corresponding to the UL/DL configuration 3. Here, as UL LBT is performed in the subframe 4 that is a UL subframe, HARQ-ACKs of DL subframes 0, 9 corresponding to the UL subframe are not able to be fed back.

Therefore, the user terminal delays the HARQ-ACK feedback, which coincides with the LBT subframe, until a next available UL subframe (here, UL subframe 2 in the radio frame M) and feeds the HARQ-ACKs back. The UL subframe for delay transmission is not limited to the first available subframe.

The radio base station may perform retransmission before receiving A/N that is transmitted in delay from the user terminal, but if there is no DL subframe for retransmission until the A/N is transmitted in delay, it is possible to avoid unnecessary retransmission control. In addition, when A/N transmitted in delay is ACK, it is possible to reduce the number of retransmissions from the radio base station.

FIG. 14 illustrates the case where the LBT periodicity is 10 ms and the UL/DL configuration 1 is used (subframe 7 is a UL LBT subframe). Here, the LBT result of the radio frame M is LBT_idle, but the LBT result of the radio frame M−1 is LBT_busy. Accordingly, the user terminal changes the HARQ-ACK timing in the first half frame of the radio frame M (Embodiment 1). Here, the HARQ-ACK timing corresponding to the UL/DL configuration 4 is used in the first half frame of the radio frame M.

In addition, in the second half frame of the radio frame M, the HARQ-ACK timing of the UL/DL configuration 1 is used. In this case, the HARQ-ACK timing corresponding to the subframes 0, 1 coincides with the subframe 7 that is the LBT subframe. Accordingly, the use terminal controls to feed back the HARQ-ACKs corresponding to the subframes 0, 1 by using a next available UL subframe (here, UL subframe 8)

As the HARQ-ACK that is not able to be transmitted due to collision with the LBT subframe is transmitted in a next available subframe, it is possible to reduce HARQ-ACK feedback delay. Here, the user terminal may perform HARQ-ACK feedback not necessarily by using the next available UL subframe, but by using any UL subframe after the UL subframe.

### Third Embodiment

In the third embodiment, description is made of the case where when UL transmission in the user terminal is restricted by the LBT result (LBT_busy), a transmission acknowledgement signal to be allocated to the transmitted-restricted UL subframe is flexibly controlled to be delayed (not based on the timing specified in the UL/DL configuration).

For example, in the third embodiment, the user terminal is controlled to feed back an HARQ-ACK by using any UL subframe that becomes available 4 ms after receiving a DL subframe or special subframe.

In this case, the user terminal is able to report the HARQ-ACK bit together with information about a subframe associated with the HARQ-ACK and/or information about HARQ process numbers (DL HARQ process IDs) by using the selected UL subframe. The information about the subframe associated with the HARQ-ACK may be a subframe number corresponding to the HARQ-ACK (DL subframe number or special subframe number). The user terminal is able to transmit HARQ-ACK, information about the subframe associated with the HARQ-ACK and/or information about the HARQ process number by using the bitmap.

Otherwise, the user terminal may bundle a part or all of HARQ-ACK to transmit in delay and feed back an HARQ-ACK bit (bundling result) by using a selected UL subframe. Here, bundling of HARQ-ACKs means selecting ACK when all HARQ-ACK results are ACK and selecting NACK when at least one of HARQ-ACK results is NACK.

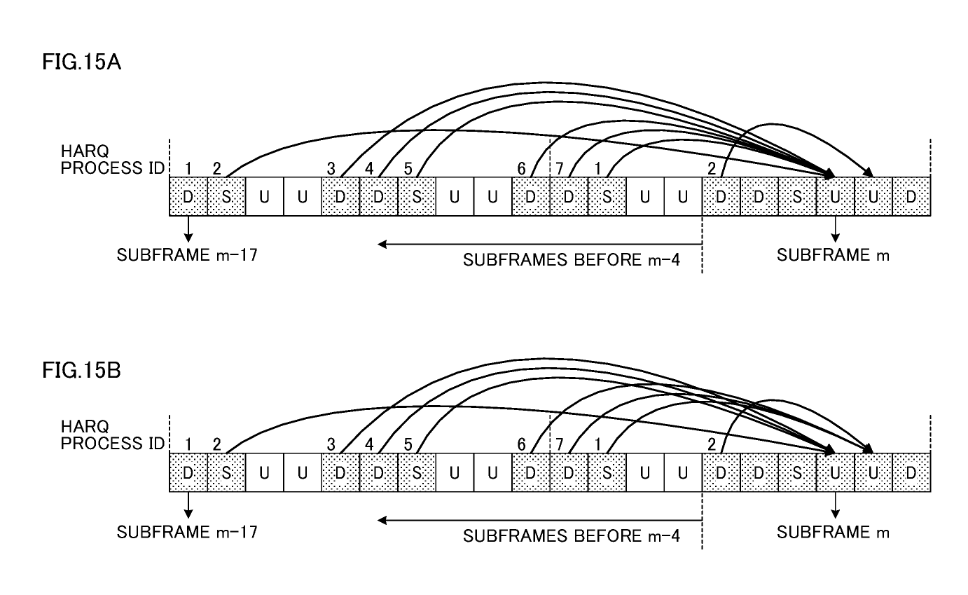

FIG. 15 illustrates the case where when the UL-LBT is LBT_busy, the user terminal transmits an HARQ-ACK bit that is not able to be transmitted in the UL subframe that is LBT_busy, and the bitmap indicating a subframe associated with the HARQ-ACK or an HARQ-ACK process number by using a UL subframe (available/idle UL subframe) that will become available later.

FIG. 15A shows that the user terminal reports the HARQ-ACK bit and bitmap by using UL subframe m that is available for UL transmission. The bitmap indicates a DL subframe associated with the HARQ-ACK bit or HARQ process number.

In FIG. 15A, HARQ-ACK feedback is performed using the first available UL subframe 4 ms after receiving a DL signal, but this is not intended to limit the present invention. For example, HARQ-ACK allocation may be distributed in consideration of the overhead of the UL subframe. In FIG. 15B, HARQ-ACK bits are allocated to be distributed into two UL subframes.

As illustrated in FIG. 15, when the user terminal feeds back the bitmap we well as the HARQ-ACK bit by using PUCCH, it may be possible to define a new PUCCH format that is different from existing PUCCH formats (PUCCH formats 1, 1a/1b, 2, 2a/2b, 3). In addition, as for the bitmap size that the user terminal applies, it may be configured to be equal to the maximum number of HARQ processes in LTE (the maximum number of HARQ processes “15” of TDD UL/DL configuration 5).

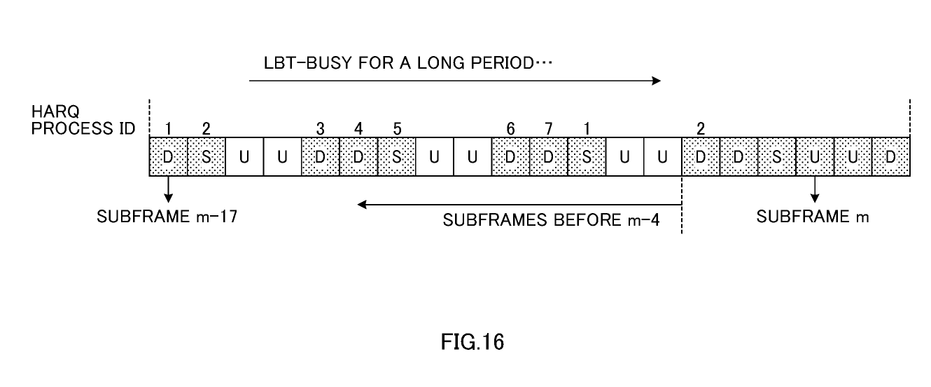

FIG. 16 illustrates control of HARQ-ACK to feed back based on the HARQ process number. Generally, the user terminal performs parallel processing of HARQs for the respective HARQ process numbers and does not process a plurality of data pieces of the same HARQ process number. Accordingly, the user terminal does not need to feed back a plurality of HARQ-ACKs corresponding to the same HARQ process number. If the LBT_busy period is continued long and an HARQ-ACK of the same HARQ process number is held, it may be controlled to feed back only the latest HARQ-ACK. That is, when the LBT_busy period is continued and the user terminal receives data of the same HARQ process number as the previously received process number, the user terminal may destroy HARQ-ACK corresponding to the previous data of the same HARQ process number and replace it with the HARQ-ACK corresponding to the latest data of the same HARQ process number.

In FIG. 16, the HARQ-ACK of the HARQ process number 1 corresponding to the subframe m-17 is also found in the subframe m-6. Accordingly, the user terminal may be configured to report HARQ-ACK corresponding to the subframe m-6 and not to report HARQ-ACK corresponding to the subframe m-17. Thus, since the HARQ-ACK to feed back is selected in consideration of the HARQ process number, it is possible to minimize the overhead of HARQ-ACK to allocate to the UL subframe.

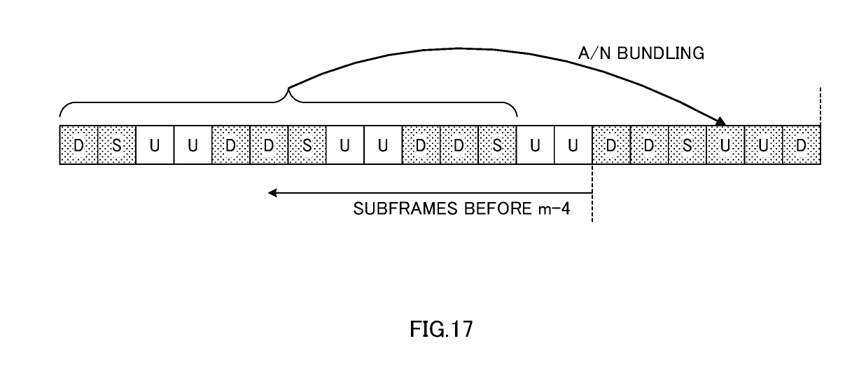

FIG. 17 illustrates the case where the user terminal performs bundling of HARQ-ACKs to transmit in delay and feeds back a bundling result (HARQ-ACK bit) by using an available UL subframe. In FIG. 17, a plurality of HARQ-ACKs that have not been able to be transmitted in UL subframes as a result of the LBT_busy are bundled and fed back by using an available given UL subframe. In FIG. 17, it is also assumed that all HARQ-ACKs that have not being able to be transmitted 4 ms prior to a given UL subframe m are bundled.

When bundling HARQ-ACKs, the user terminal is able to report an HARQ-ACK bit of HARQ-ACKs bundled without use of the bitmap. In addition, the radio base station is able to know what DL subframe the reported HARQ-ACK bit corresponds to based on the timing when the HARQ-ACK bit is reported.

### Modified Embodiment

In HARQ-ACK feedback, the user terminal performs the processing of storing error reception data in a buffer memory for retransmission control and combining it with data that is to be retransmitted later. At this time, the soft buffer size (N_{IR}) is divided in accordance with the maximum HARQ process number (M_{DL}_{_}_{HARQ}) performed between the radio base stations and is reduced in accordance with the division number (se equation (1)). Accordingly, it is important in HARQ-ARCK feedback control to determine the division number of the soft buffer size.

$${N}_{IR} = ⌊ \frac{{N}_{soft}}{{K}_{C} \cdot {K}_{MIMO} \cdot min ( {M}_{DL\_HARQ} , {M}_{limit} )} ⌋ \qquad ( EQUATION 1 )$$

In the present embodiment, control is made by changing the HARQ-ACK timing that the user terminal applies. In this case, it is important how to select the division number of the soft buffer size. For example, as described in the first embodiment, when the UL/DL configuration to use is as HARQ-ACK timing is changed, the number of HARQ processes is also changed. Accordingly, in the present embodiment, the division number of the soft buffer size is determined in consideration the number of HARQ processes when the HARQ-ACK timing is changed.

As illustrated in the first embodiment, when the UL/DL configuration to use as HARQ-ACK timing is changed, consideration is made of the number of HARQ processes of the base UL/DL configuration before change and the number of HARQ processes of the UL/DL configuration after change that is changed in accordance with the LBT result. Specifically, the division number of the soft buffer size is determined based on the number of HARQ processes that becomes maximum among the multiple UL/DL configurations.

In addition, as illustrated in the third embodiment, when controlling the HARQ-ACK feedback flexibly, the division number of the soft buffer size is determined based on the number of HARQ processes that can be maximum based on the HARQ-ACK timing. For example, the division number of the soft buffer size may be determined based on the maximum number of HARQ processes (15).

### (Configuration of Radio Communication System)

Next description is made about the configuration of a radio communication system according to the present embodiment. This radio communication system is applied with the radio communication methods according to the first to third embodiments. The configurations according to the above-mentioned first to third embodiments may be employed alone or in combination.

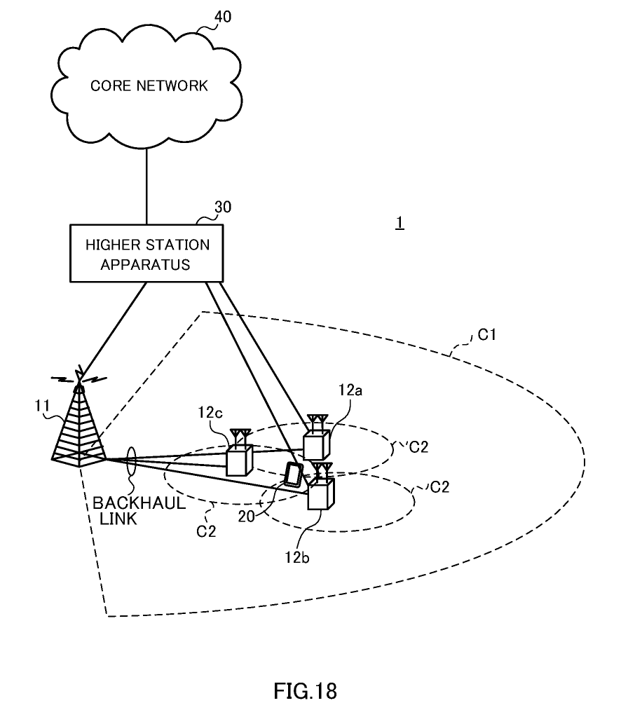

FIG. 18 is a diagram schematically illustrating the configuration of a radio communication system according to the present embodiment. The radio communication system illustrated in FIG. 18 is, for example, a system covering an LTE system, SUPER 3G. In this radio communication system, carrier aggregation (CA) or dual connectivity (DC) can be applied by aggregating a plurality of fundamental frequency blocks (component carriers), each component carrier corresponding to the system bandwidth of the LTE system. Besides, the radio communication system illustrated in FIG. 18 has a licensed band and an unlicensed band (LTE-U base station). This radio communication system may be called IMT-Advanced, 4G, FRA (Future Radio Access) or the like.

The radio communication system 1 illustrated in FIG. 18 has a radio base station 11 forming a macro cell C1 and radio base stations 12a to 12c each forming a small cell C2 that is smaller than the macro cell C1 and is located within the macro cell C1. In the macro cell C1 and the small cells C2, a user terminal 20 is located. For example, it can be configured that the macro cell C1 is used with a licensed band, at least one of the small cells C2 is used with an unlicensed band (LTE-U). It can be also configured that in addition to the macro cell, a part of the small cells C2 is used with a licensed band and the other C2 is used with an unlicensed band.

The user terminal 20 is able to be connected to both of the radio base station 11 and the radio base stations 12. The user terminal 20 is expected to use the macro cell C1 and small cell C2 of different frequencies simultaneously by CA or DC. In this case, the radio base station 11 using the licensed band may transmit information (assist information) about the radio base station 12 using the unlicensed band to the user terminal 20. Further, when carrier aggregation is carried out with the licensed and unlicensed bands, one radio base station (for example, radio base station 11) may be configured to control scheduling of the licensed and unlicensed band cells.

The user terminal 20 and the radio base station 11 are able to perform communication with each other using a carrier of relatively low frequency band (for example, 2 GHz) and narrow bandwidth (called legacy carrier). On the other hand, the user terminal 20 and the radio base station 12 are able to perform communication with each other using a carrier of relatively high frequency band (for example, 3.5 GHz, 5 GHz or the like) and wide bandwidth or using the same carrier as that used in communication between the user terminal and the radio base station 11. Connection between the radio base station 11 and the radio base station 12 (or between two radio base stations 12) may be wired connection (optical fiber, X2 interface or the like) or wireless communication.

The radio base station 11 and radio base stations 12 are each connected to a higher station apparatus 30 and also connected to a core network 40 via the higher station apparatus 30. The higher station apparatus 30 includes, but is not limited to, for example, an access gateway apparatus, a radio network controller (RNC), mobility management entity (MME) and so on. Each radio base station 12 may be connected to the higher station apparatus 30 via the radio base station 11.

The radio base station 11 is a radio base station having a relatively wide coverage, may be called eNode B, macro base station, transmission/reception point or the like. The radio base station 12 is a radio base station having a local coverage and may be called small base station, pico base station, femto base station Home eNodeB, RRH (Remote Radio Head), micro base station, transmission/reception point or the like. In the following description, the radio base stations 11 and 12 are treated collectively as a radio base station 10, unless specified otherwise. Each user terminal 20 is a terminal supporting various communication schemes such as LTE and LTE-A and may include not only a mobile communication terminal, but also a fixed communication terminal.

In the radio communication system 1, as radio access schemes, OFDMA (Orthogonal Frequency Division Multiple Access) is applied to the downlink, and SC-FDMA (Single-Carrier Frequency-Division Multiple Access) is applied to the uplink. OFDMA is a multi-carrier transmission scheme to perform communication by dividing a frequency band into a plurality of narrow frequency bands (subcarriers) and mapping data to each subcarrier. SC-FDMA is a single carrier transmission scheme to perform communications by dividing, per terminal, the system band into bands formed with one or continuous resource blocks, and allowing a plurality of terminals to use mutually different bands thereby to reduce interference between terminals.

Here, description is made about communication channels used in the radio communication system illustrated in FIG. 18. Downlink channels as used include a PDSCH (Physical Downlink Shared Channel) used by each user terminal 20 on a shared basis and a downlink L1/L2 control channel (PCFICH, PHICH, PDCCH, enhanced PDCCH). PDSCH is used to transmit user data and higher layer control information. The PDCCH (Physical Downlink Control Channel) is used to transmit PDSCH and PUSCH scheduling information and so on. PCHICH (Physical Control Format Indicator Channel) is used to transmit the number of OFDM symbols to use in PDCCH. PHICH (Physical Hybrid-ARQ Indicator Channel) is used to transmit HARQ ACK/NACK in response to PUSCH. In addition, the enhanced PDCCH (EPDCCH) may be used to transmit PDSCH and PUSCH scheduling information and so on. This EPDCCH is frequency-division-multiplexed with PDSCH (downlink shared data channel).

Uplink channels include a PUSCH (Physical Uplink Shared Channel), which is an uplink data channel used by each user terminal 20 on a shared basis, and a PUCCH (Physical Uplink Control Channel) that is an uplink control channel. The PUSCH is used to transmit user data and higher layer control information. The PUCCH is used to transmit downlink channel state information (CSI), transmission acknowledgement signals (also called HARQ-ACK, A/N or ACK/NACK), scheduling request (SR) and so on. The channel state information includes radio quality information (CQI: Channel Quality Indicator), precoding matric indicator (PMI), rank indicator (RI) and so on.

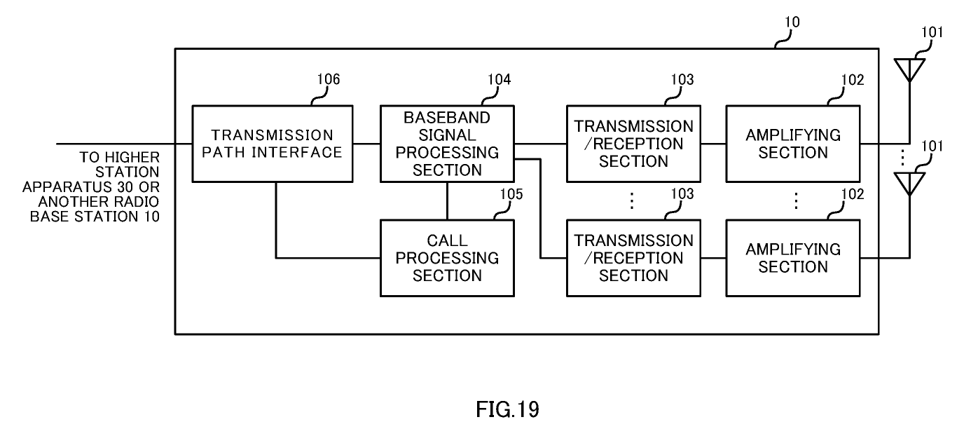

FIG. 19 is a diagram of an overall configuration of the radio base station 10 (including the radio base stations 11 and 12) according to the present embodiment. The radio base station 10 has a plurality of transmission/reception antennas 101 for MIMO transmission, amplifying sections 102, transmission/reception sections 103 (transmission sections/reception sections), a baseband signal processing section 104, a call processing section 105 and a transmission path interface 106.

User data that is transmitted on the downlink from the radio base station 10 to the user terminal 20 is input from the higher station apparatus 30, through the transmission path interface 106, into the baseband signal processing section 104.

In the baseband signal processing section 104, signals are subjected to PDCP (Packet Data Convergence Protocol) layer processing, RLC (Radio Link Control) layer transmission processing such as division and coupling of user data and RLC retransmission control transmission processing, MAC (Medium Access Control) retransmission control, including, for example, HARQ (Hybrid Automatic Repeat reQuest) transmission processing, scheduling, transport format selection, channel coding, inverse fast Fourier transform (IFFT) processing, and precoding processing. Then, the resultant signals are transferred to each transmission/reception section 103. As for downlink control signals, transmission processing is performed, including channel coding and inverse fast Fourier transform, and the resultant signals are transmitted to each transmission/reception section 103.

Also, the baseband signal processing section 104 transmits, to the user terminal 20, control information for communication in the cell (system information) by higher layer signaling (for example, RRC signaling, broadcast information or the like). Information for communication in the cell includes, for example, uplink or downlink system bandwidth and so on.

The transmission/reception sections 103 of the radio base station 10 are able to transmit information about LBT (for example, a part or all of LBT subframe, LBT symbol, LBT periodicity) to the user terminal. In addition, when LBT is applied in TDD, the radio base station 10 transmits, to the user terminal, information about UL/DL configuration (or DL-Reference UL/DL configuration that is UL/DL configuration defining HARQ-ACK timing). For example, the radio base station 10 provides these information pieces to the user terminal via the licensed band and/or unlicensed band. Besides, the radio base station 10 may transmit DL-BRS when the LBT result is LBT_idle.

In each transmission/reception section 103, baseband signals which are precoded per antenna and output from the baseband signal processing section 104 are subjected to frequency conversion processing into a radio frequency band. The radio frequency signals having been subjected to frequency conversion at the transmission/reception section 103 are amplified by the amplifying section 102, and the resultant signals are transmitted from the transmission/reception antenna 101. The transmission/reception section (transmission section/reception section) 103 may be configured of a transmitter/receiver, transmission/reception circuit (transmission circuit/reception circuit) or transmission/reception apparatus (transmission apparatus/reception apparatus) as used in the technical field to which the present invention pertains.

Meanwhile, as for data transmitted from the use terminal 20 to the radio base station 10 in uplink, radio frequency signals are received in each transmission/reception antenna 101, and amplified in the amplifying section 102. Then, in the transmission/reception section 103, reception signals are subjected to frequency conversion and converted into baseband signals, and are input to the baseband signal processing section 104.

The baseband signal processing section 104 performs FFT (Fast Fourier Transform) processing, IDFT (Inverse Discrete Fourier Transform) processing, error correction decoding, MAC retransmission control reception processing, and RLC layer and PDCP layer reception processing on the user data included in the received baseband signals. Then, the resultant signals are transferred to the higher station apparatus 30 through the transmission path interface 106. The call processing section 105 performs call processing such as setting up and releasing a communication channel, manages the state of the radio base station 10 and manages the radio resources.

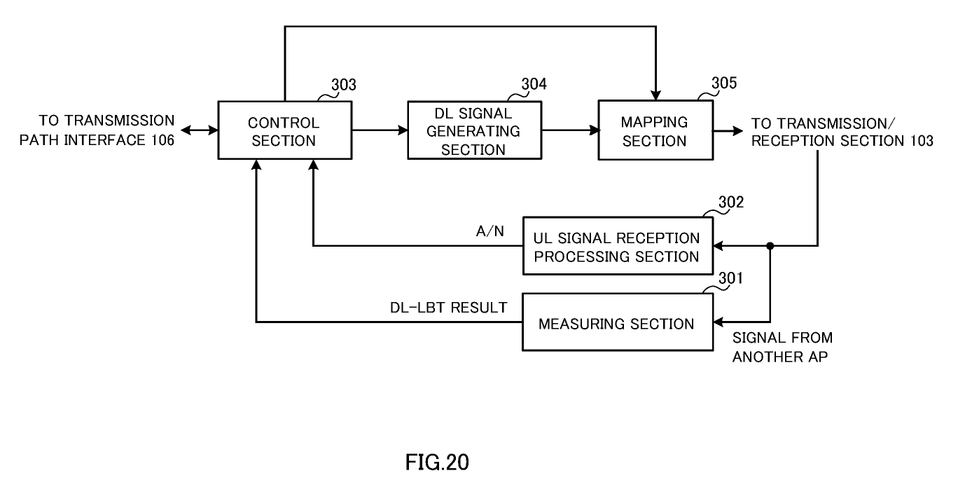

FIG. 20 is a diagram illustrating a functional configuration of the baseband signal processing section 104 of the radio base station 10 according to the present embodiment. The functional configuration in FIG. 20 is mainly of featuring parts according to the present embodiment, however the radio base station 10 may also have other functional blocks required for radio communication.

As illustrated in FIG. 20, the radio base station 10 is configured to include a measuring section 301, a UL signal reception processing section 302, a control section (scheduler) 303, a DL signal generating section 304 and a mapping section (allocation control section) 305.

The measuring section 301 performs detection/measurement (LBT) of a signal transmitted from another transmission point (AP/TP) in the unlicensed band. Specifically, the measuring section 301 performs detection/measurement of a signal transmitted from another transmission point, for example, at a given timing before transmitting the DL signal, and outputs its detection/measurement result (LBT result) to the control section 303. For example, the measuring section 301 determines whether or not the power level of a detected signal is equal to or greater than a given threshold and provides its determination result (LBT result) to the control section 303. The measuring section 301 may be configured to be a measurement circuit or a measuring unit as used in the technical field to which the present invention pertains.

The UL signal reception processing section 302 performs reception processing (for example, decoding processing, demodulating processing and so on) on UL signals (PUSCCH signal, PUSCH signal and so on) transmitted from the user terminal. Information obtained in the UL signal reception processing section 302 (for example, HARQ-ACK transmitted from the user terminal and so on) is output to the control section 303. Here, the UL signal reception processing section 302 may be configured of a signal processing unit or a signal processing circuit as used in the technical field to which the present invention pertains.

The controller (scheduler) 303 controls allocation to radio resources (transmission timing) of downlink control signals (UL grant/DL assignment) to be transmitted in PDCCH and/or enhanced PDCCH (EPDCCH) and downlink data signals to be transmitted in the PDSCH. The control section 303 also controls allocation (transmission timing) of system information (PBCH), synchronization signals (PSS/SSS), downlink reference signals (CRS, CSI-RS and so on). The control section 303 may be configured of a controller, a scheduler, a control circuit or a control device as used in the technical field to which the present invention pertains.

The control section 303 controls transmission of DL signals in the unlicensed band based on the LBT result output from the measuring section 301. In addition, based on a HARQ-ACK result transmitted from the user terminal, the control section 303 performs retransmission of a downlink data signal (for the “NACK” case) or transmission of a new downlink data signal (for the “ACK” case).

As for the HARQ-ACK fed back from the user terminal, its transmission is controlled based on the LBT result in UL. The HARQ-ACK is also controlled as to its feedback timing in accordance with the LBT result in a UL subframe before the UL subframe with which the user terminal transmits the HARQ-ACK (FIGS. 6, 7, 11, 15-17 mentioned above). In addition, the HARQ-ACK fed back from the user terminal is controlled as to its feedback timing in consideration of the position of a UL-LBT subframe (see FIGS. 13 and 14 described above).

The DL signal generating section 304 generates a DL signal based on the instruction from the control section 303. The DL signal may be a DL control signal (PDCCH signal, EPDCCH signal, PDD/SSS signal, PBCH signal or the like), a downlink data signal (PDSCH signal), a downlink reference signal (CRS, CSI-RS, DM-RS or the like), etc. The DL signal generating section 304 may generate a DL-BRS when the DL-LBT result shows LBT_idle. The DL signal generating section 304 may be configured of a signal generator or a signal generating circuit as used in the technical field to which the present invention pertains.

Further, the mapping section (allocation control section) 305 controls mapping (allocation) of DL signals based on the instruction from the control section 303. Specifically, when the LBT result output from the measuring section 301 shows that DL signal transmission is allowed, the mapping section 305 performs DL signal allocation. The mapping section 305 may be configured of a mapping circuit or a mapper as used in the technical field to which the present invention pertains.

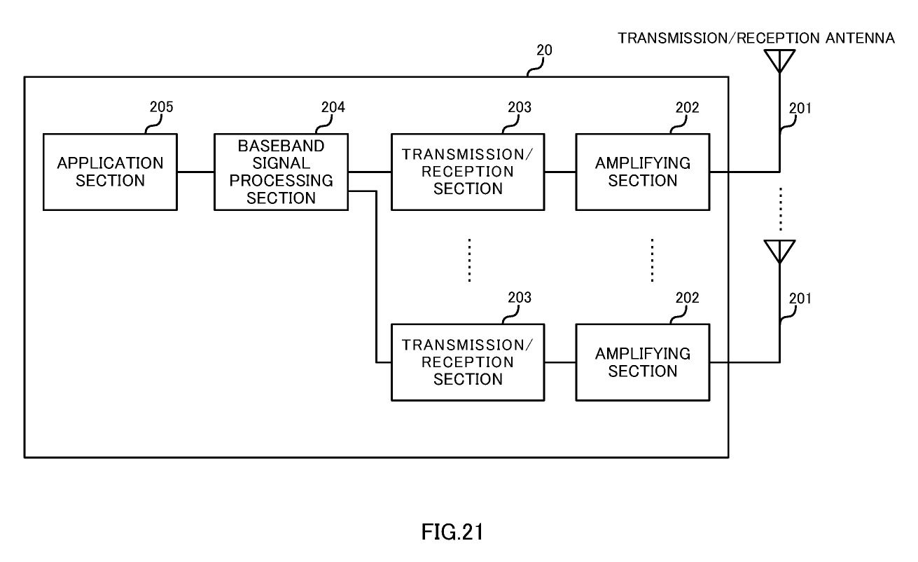

FIG. 21 is a diagram of an overall configuration of the user terminal 20 according to the present embodiment. The user terminal 20 has a plurality of transmission/reception antennas 201 for MIMO transmission, amplifying sections 202, transmission/reception sections 203 (transmission sections/reception sections), a baseband signal processing section 204 and an application section 205.

As for downlink data, radio frequency signals are received in the transmission/reception antennas 201 and are amplified in the respective amplifying sections 202, and subjected to frequency conversion into baseband signals in the transmission/reception sections 203. The converted baseband signals are then, input to the baseband signal processing section 204, where the signals are subjected to the FFT processing, error correction coding, retransmission control (Hybrid ARQ) reception processing and so on. In the downlink data, downlink user data is transferred to the application section 205. The application section 205 performs processing related to higher layers above the physical layer and the MAC layer. In the downlink data, broadcast information is also transferred to the application section 205.

On the other hand, uplink user data is input from the application section 205 to the baseband signal processing section 204. In the baseband signal processing section 204, retransmission control (Hybrid ARQ) transmission processing, channel coding, precoding, DFT (Discrete Fourier Transform) processing, IFFT processing and so on are performed, and the resultant signals are transferred to each transmission/reception section 203.

In the transmission/reception section 203, the baseband signals output from the baseband signal processing section 204 are converted into a radio frequency band. After that, the frequency-converted radio frequency signals are amplified in the amplifying section 202, and then, transmitted from the transmission/reception antenna 201. When the UL-LBT result shows LBT_idle, the transmission/reception section 203 may be able to transmit UL-BRS. The transmission/reception section (transmission section/reception section) 203 may be configured of a transmitter/receiver, a transmission/reception circuit (transmission circuit/reception circuit) or a transmission/reception apparatus (transmission apparatus/reception apparatus) as used in the technical field to which the present invention pertains.

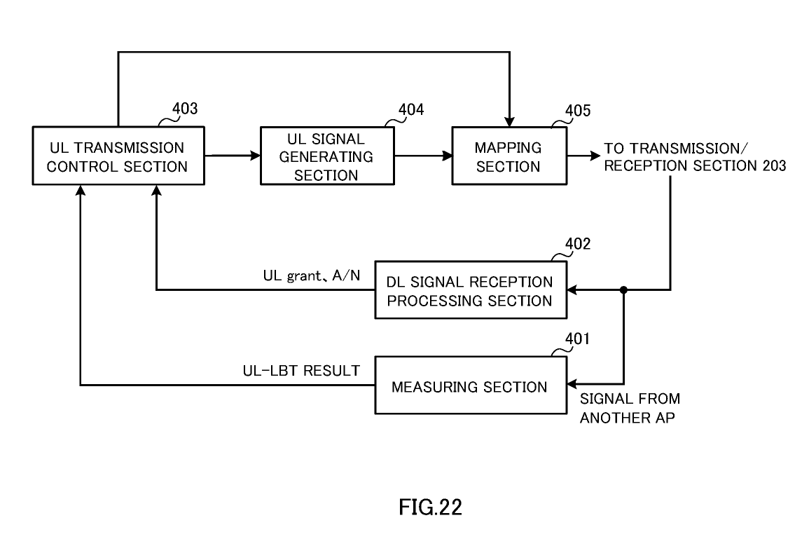

FIG. 22 is a diagram illustrating a functional configuration of the baseband signal processing section 204 of the user terminal 20. The functional configuration in FIG. 22 is mainly of featuring parts according to the present embodiment, and the user terminal 20 may also have other functional blocks required for radio communication.

As illustrated in FIG. 22, the user terminal 20 has a measuring section 401, a DL signal reception processing section 402, a UL transmission control section 403 (control section), a UL signal generating section 404 and a mapping section 405. If LBT in UL transmission is performed at the radio base station side, the measuring section 401 may be omitted.

The measuring section 401 performs detection/measurement (LBT) of a signal transmitted from another transmission point (AP/TP) in UL. Specifically, the measuring section 401 performs detection/measurement of a signal from another transmission point, for example, at a given timing before transmitting a UL signal and outputs its detection/measurement result (LBT result) to the UL transmission control section 403. For example, the measuring section 401 determines whether or not the power level of a detected signal is equal to or greater than a threshold and provides its determination result (LBT result) to the UL transmission control section 403. The measuring section 401 may be a measuring unit or a measurement circuit as used in the technical field to which the present invention pertains.

The DL signal reception processing section 402 performs reception processing (for example, decoding processing, demodulation processing and so on) on DL signals transmitted in the licensed band or unlicensed band. For example, the DL signal reception processing section 402 obtains UL grant included in a downlink control signal (for example, DCI formats 0, 4) and outputs it to the UL transmission control section 403.

Further, the DL signal reception processing section 402 outputs a result of the reception processing in response to a DL signal transmitted from the radio base station (a downlink data signal transmitted in the PDSCH) (whether or not to perform retransmission control) to the UL transmission control section 403. The DL signal reception processing section 402 may be configured of a signal processing unit or a signal processing circuit as used in the technical field to which the present invention pertains.

The UL transmission control section 403 controls transmission of UL signals (UL data signals, UL control signals, reference signals and so on) for the radio base station in the licensed band and in the unlicensed band. The UL transmission control section 403 controls transmission in the unlicensed band based on a detection/measurement result (LBT result) from the measuring section 401. That is, the UL transmission control section 403 controls transmission of a UL signal in the unlicensed band in consideration of UL transmission instruction (UL grant) transmitted from the radio base station and the detection result (LBT result) from the measuring section 401.

Further, the UL transmission control section 403 performs retransmission control based on the reception processing result from the DL signal reception processing section 402. For example, the UL transmission control section 403 controls to feed back ACK if a downlink data signal is received successfully and to feed back NACK if the downlink signal was not able to be received successfully. In this case, in the UL subframe to transmit the UL signal, the UL transmission control section 403 controls the feedback timing of a transmission acknowledgement signal (A/N) in accordance with the LBT result in a UL subframe prior to the UL subframe to transmit the UL signal.

For example, when UL-LBT is performed on a per given radio frame basis (LBT periodicity), the UL transmission control section 403 is able to control the A/N feedback timing based on the LBT result of the last radio frame unit N−1 before a radio frame unit N where the UL subframe to transmit the UL signal is allocated.

Specifically, when the LBT result of the last radio frame unit before the radio frame where the UL subframe to transmit the UL signal is allocated shows LBT_busy, the UL transmission control section 403 applies a different UL/DL configuration from the given UL/DL configuration to perform A/N feedback.

For example, assume that UL-LBT is performed at the 5 ms periodicity, the LBT result of a given half radio frame N is LBT_idle and the LBT result of the half radio frame N−1 is LBT_busy. The UL transmission control section 403 changes A/N to feed back in a UL subframe of the half radio frame N (A/N to allocate to the UL subframe) if transmission is performed with any of the UL/DL configurations 0, 1, 2, 6 having a DL-UL switching configuration of 5 ms (for example, see FIGS. 6 and 7 described above).

In addition, assume that UL-LBT is performed at the 10 ms periodicity, the LBT result of a given radio frame M is LBT_idle and the LBT result of the radio frame M−1 is LBT_busy. The UL transmission control section 403 changes A/N to feed back in a first half frame of the radio frame M (A/N to allocate to the UL subframe) if transmission is performed with any of the UL/DL configurations 0, 1, 2, 6 having a DL-UL switching configuration of 5 ms (for example, see FIG. 11 described above).

Further, when a UL subframe to allocate a retransmission control signal corresponds to a UL subframe to perform LBT, the UL transmission control section 403 allocates the retransmission control signal to an available UL subframe after the UL subframe to perform the LBT (for example, see FIGS. 14 and 15 described above).

Or, when changing the UL subframe to transmit a retransmission control signal based on the LBT result, the UL transmission control section 403 controls to transmit bit information of the retransmission control signal and a bitmap associated with a subframe corresponding to each retransmission control signal (see FIG. 16 described above). The UL transmission control section 403 may be configured of a control circuit or a control device as used in the technical field to which the present invention pertains.

The UL signal generating section 404 generates a UL signal based on the instruction from the UL transmission control section 403. As for the UL signal, it may be a UL control signal (PUCCH signal, PRACH signal or the like), a UL data signal (PUSCH signal), a reference signal (SRS, DM-RS or the like), etc. When the UL-LBT results shows LBT_idle, the UL signal generating section 404 may generate UL-BRS. The UL signal generating section 404 may be configured of a signal generator or a signal generating circuit as used in the technical field to which the present invention pertains.

Further, the mapping section (allocation control section) 405 controls mapping (allocation) of a UL signal from the instruction from the UL transmission control section 403. Specifically, when the LBT result output from the measuring section 401 shows that UL signal transmission is enabled, the mapping section 405 performs UL signal allocation. The mapping section 405 maps an uplink control signal including HARQ-ACK to the PUCCH when there is no transmission of an uplink data signal (PUSCH signal) or to PUSCH when there is transmission of an uplink data signal. The mapping section 405 may be configured of a mapping circuit or a mapper as used in the technical field to which the present invention pertains.

Thus, according to the present embodiment, HARQ-ACK feedback is controlled based on the UL-LBT result. With this configuration, it is possible to feed back HARQ-ACK appropriately irrespective of the LBT result, thereby preventing deterioration of communication quality.

Here, in the above description, it is assumed that non-licensed band cell controls whether to enable transmission of a DL signal or not in accordance with the LBT result. However, the present embodiment is not limited to such a case, and may apply even in the case of transition to another carrier by DFS (Dynamic Frequency Selection) or transmission power control (TPC) in accordance with the LBT result.

Now, although the present invention has been described in detail with reference to the above embodiment, it should be obvious to a person skilled in the art that the present invention is by no means limited to the embodiments described herein. The present invention can be implemented with various corrections and in various modifications, without departing from the spirit and scope of the present invention defined by the recitations of the claims. For example, the above-described embodiments may be implemented in combination. Consequently, the descriptions herein are provided for the illustrative purpose only, and should by no means be construed to limit the present invention in any way.

The disclosure of Japanese Patent Application No. 2014-195457 filed on Sep. 25, 2014, including the specification, drawings, and abstract, is incorporated herein by reference in its entirety.

1. A user terminal comprising:
a transmission section that transmits a transmission acknowledgement signal for a DL (downlink) data signal transmitted from a radio base station; and
a control section that controls transmission of the transmission acknowledgement signal based on an LBT (Listen Before Talk) result in uplink,
wherein when transmitting the transmission acknowledgement signal in a given UL (uplink) subframe, the control section determines a feedback timing of the transmission acknowledgement signal in accordance with the LBT result in a UL subframe prior to the given UL subframe.

2. The user terminal according to claim 1, wherein when uplink LBT is performed on a per given radio frame basis, the control section controls the feedback timing of the transmission acknowledgement signal in accordance with the LBT result in a radio frame unit N−1 that is one before a radio frame unit N where the given UL subframe is allocated.

3. The user terminal according to claim 2, wherein when the transmission section performs transmission based on a given TDD UL/DL configuration, the LBT result in the radio frame unit N shows LBT_idle and the LBT result in the radio frame unit N−1 shows LBT_busy, the control section controls feedback of the transmission acknowledgement signal with reference to a UL/DL configuration that is different from the given TDD UL/DL configuration.

4. The user terminal according to claim 3, wherein when the uplink LBT is performed in 5 ms unit, the LBT result in a half radio frame N shows LBT_idle, the LBT result in a half radio frame N−1 that is one before the half radio frame N shows LBT_busy, and the transmission section performs transmission with use of any of UL/DL configurations 0, 1, 2 and 6, the control section feeds back the transmission acknowledgement signal in a UL subframe of the half radio frame N with reference to any of UL/DL configurations 3, 4 and 5.

5. The user terminal according to claim 3, wherein when the uplink LBT is performed in 10 ms unit, the LBT result in a radio frame M shows LBT_idle, the LBT result in a radio frame M−1 that is one before the radio frame M shows LBT_busy, and the transmission section performs transmission with use of any of UL/DL configurations 0, 1, 2 and 6, the control section feeds back the transmission acknowledgement signal in a UL subframe in a first half of the radio frame M with reference to any of UL/DL configurations 3, 4 and 5.

6. The user terminal according to claim 1, wherein when a UL subframe to allocate a retransmission control signal is a UL subframe to perform LBT, the control section allocates the retransmission control signal to a UL subframe that is available after the UL subframe to perform the LBT.

7. The user terminal according to claim 1, wherein when a UL subframe to transmit a retransmission control signal is changed based on the LBT result, the transmission section transmits bit information of the retransmission control signal and a bitmap indicating HARQ process numbers or subframe information corresponding to each retransmission control signal.

8. The user terminal according to claim 1, wherein a UL subframe to transmit a retransmission control signal is changed based on the LBT result, the transmission section bundles a plurality of transmission acknowledgement signals to allocate to a UL subframe after change and feeds back the transmission acknowledgement signals.

9. A radio base station comprising:
a reception section that receives a transmission acknowledgement signal transmitted from a user terminal; and
a control section that performs retransmission control of a DL (downlink) data signal based on the transmission acknowledgement signal,
wherein transmission of the transmission acknowledgement signal is controlled in accordance with an LBT (Listen Before Talk) result in uplink and a feedback timing of the transmission acknowledgement signal is determined in accordance with the LBT result in a UL subframe before a given UL subframe to transmit the transmission acknowledgement signal.

10. A radio communication method for a user terminal that controls transmission in accordance with an LBT (Listen Before Talk) result in uplink, the radio communication method comprising:
generating a transmission acknowledgement signal for a DL (downlink) data signal transmitted from a radio base station; and
controlling transmission of the transmission acknowledgement signal based on the LBT result,
wherein when transmitting the transmission acknowledgement signal in a given UL (uplink) subframe, the user terminal determines a feedback timing of the transmission acknowledgement signal in accordance with the LBT result in a UL subframe prior to the given UL subframe.

11. The user terminal according to claim 2, wherein when a UL subframe to transmit a retransmission control signal is changed based on the LBT result, the transmission section transmits bit information of the retransmission control signal and a bitmap indicating HARQ process numbers or subframe information corresponding to each retransmission control signal.

12. The user terminal according to claim 2, wherein a UL subframe to transmit a retransmission control signal is changed based on the LBT result, the transmission section bundles a plurality of transmission acknowledgement signals to allocate to a UL subframe after change and feeds back the transmission acknowledgement signals.
